(19) United States
(12) Patent Application Publication
(10) Pub. No.: US 2016/0307237 A1
(43) Pub. Date: Oct. 20, 2016

(54) Accessing Advertised Application States From A Current Application State

(71) Applicant: Quixey, Inc., Mountain View, CA (US)

(72) Inventors: Eric J. Glover, Palo Alto, CA (US); Michael Travers, Pacifica, CA (US); David Hytha, Oakland, CA (US)

(73) Assignee: Quixey, Inc., Mountain View, CA (US)

(21) Appl. No.: 15/130,363

(22) Filed: Apr. 15, 2016

Related U.S. Application Data
(60) Provisional application No. 62/148,162, filed on Apr. 15, 2015.

(51) Int. Cl. G06Q 30/02

(52) U.S. Cl. CPC G06Q 30/0275

(57) ABSTRACT

A method includes receiving, at an advertisement system, advertisement data from a plurality of advertiser devices. The method further includes generating a plurality of advertisement records, each advertisement record including an entity name, an action, and a bid price associated with an advertisement. The method further includes receiving an advertisement request from a link generation system and selecting an advertisement record having the entity name indicated in the advertisement request but a different action than the action indicated in the advertisement request. Additionally, the method includes generating an advertisement result based on the selected advertisement record and transmitting the advertisement result to the link generation system.

### CROSS-REFERENCE TO RELATED APPLICATION

This application claims priority under 35 U.S.C. §119(e) to U.S. Provisional Application No. 62/148,162, filed on Apr. 15, 2015, which is hereby incorporated by reference in its entirety.

### TECHNICAL FIELD

This disclosure relates to techniques for generating additional functionality within an application state.

### BACKGROUND

In recent years, use of computers, smartphones, and other Internet-connected devices has grown exponentially. Correspondingly, the number of available software applications for such devices has also grown. Today, many diverse native and web software applications can be accessed on any number of different devices, including, but not limited to, smartphones, personal computers, automobiles, and televisions. These diverse applications can range from business driven applications to games, educational applications, news applications, shopping applications, messaging applications, media streaming applications, social networking applications, and so much more. Furthermore, application developers develop vast amounts of applications within each genre and each application may have numerous editions. As a result, users of these Internet-connected devices have encountered the problem of finding the correct native or web software application offering the information and/or functionality that they seek. In response to this problem, techniques have arisen to connect users of these devices to relevant application and web content.

### SUMMARY

The details of one or more implementations of the disclosure are set forth in the accompanying drawings and the description below. Other aspects, features, and advantages will be apparent from the description and drawings, and from the claims.

In one example, the present disclosure is directed to a method comprising receiving, at an advertisement system including one or more processing units, advertisement data from a plurality of advertiser devices. The method further comprises generating, by the advertisement system, a plurality of advertisement records in an advertisement data store based on the advertisement data received from the plurality of advertiser devices. Each of the advertisement records includes an entity name associated with an advertisement, an action associated with the advertisement, and a bid price indicating an amount of money associated with the advertisement. The method further comprises receiving, by the advertisement system, an advertisement request from a link generation system. The advertisement request includes an entity name and an action associated with a currently accessed application state on a user device. The method further comprises selecting, by the advertisement system, an advertisement record having the entity name indicated in the advertisement request and having a different action than the action indicated in the advertisement request. Additionally, the method comprises generating, by the advertisement system, an advertisement result based on the selected advertisement record, wherein the advertisement result is configured to be displayed with the currently accessed application state on the user device. The method further comprises transmitting, by the advertisement system, the advertisement result to the link generation system.

In another example, the present disclosure is directed to a system comprising an advertisement system of one or more computing devices and a data store comprising one or more storage devices. The advertisement system is configured to receive advertisement data from a plurality of advertiser devices. The advertisement system is further configured to generate a plurality of advertisement records in an advertisement data store based on the advertisement data received from the plurality of advertiser devices. Each of the advertisement records includes an entity name associated with an advertisement, an action associated with the advertisement, and a bid price indicating an amount of money associated with the advertisement. The advertisement system is further configured to receive an advertisement request from a link generation system. The advertisement request includes an entity name and an action associated with a currently accessed application state on a user device. The advertisement system is further configured to select an advertisement record having the entity name indicated in the advertisement request and having a different action than the action indicated in the advertisement request. Additionally, the advertisement system is configured to generate an advertisement result based on the selected advertisement record, wherein the advertisement result is configured to be displayed with the currently accessed application state on the user device. The advertisement system is further configured to transmit the advertisement result to the link generation system.

### DESCRIPTION OF DRAWINGS

FIG. 1A is a schematic view of an example environment including a user device in communication with a link generation system.

FIG. 1B is a functional block diagram of a link generation system interacting with user devices and data sources.

FIG. 1C is a schematic view of an example campaign manager interface displayed on an advertiser device.

FIG. 2 is a schematic view of an example link generation system in communication with a user device and an advertisement system.

FIGS. 3A-4C are schematic views of an example user device displaying state links.

FIGS. 5A and 5B are schematic views of example entity records.

FIGS. 5C and 5D are schematic views of example application state records.

FIG. 6 illustrates an example method for generating state links.

FIG. 7 illustrates an example method for transmitting a link request and receiving link results.

FIG. 8 is a schematic view of an example computing device executing any systems or methods described herein.

FIG. 9A illustrates an example method for generating advertisement records.

FIGS. 9B and 9C are schematic views of an example advertisement record.

FIG. 10 illustrates an example method for generating advertisement results.

Like reference symbols in the various drawings indicate like elements.

### DETAILED DESCRIPTION

The present disclosure relates to enhancing a state of an application by providing access to actions that may not otherwise be accessible by that application state. For example, a user accessing an application state on a user device may be provided one or more user-selectable links to related application states (hereafter “state links”) within the currently accessed state. The state links may be advertisements (e.g., advertised state links) whereby an advertiser has agreed to pay for one or more state links to appear with one or more application states.

A link generation system of the present disclosure generates one or more state links in response to a link request received from a user device. The link request may indicate an entity (e.g., a person, place, or thing) and an action (e.g., a task performed by the corresponding application state) associated with a state currently being accessed (e.g., displayed) by the user device. The link generation system generates link results corresponding to the same entity but different actions than indicated by the link request. The link generation system may utilize an advertisement system of the present disclosure in order to configure the link results to take advantage of advertisement opportunities. The link generation system receives advertisement results that may be used to include advertisements (e.g., advertised state links) in the link results. For example, the link generation system can insert data from the advertisement results into the link results that allows a user device to render and display advertised state links. The link generation system transmits the link results to the user device. The user device may display the link results as one or more user-selectable state links and/or advertised state links that are associated with the same entity as the currently accessed application state, but that perform different actions than the currently accessed application state. By generating state links using the same entity but different actions than a currently accessed application state, the link generation system allows users to access related actions that may otherwise be inaccessible in the currently accessed application state. Moreover, by utilizing the advertisement system, the link generation system can provide state links to advertised application states in order to generate revenue.

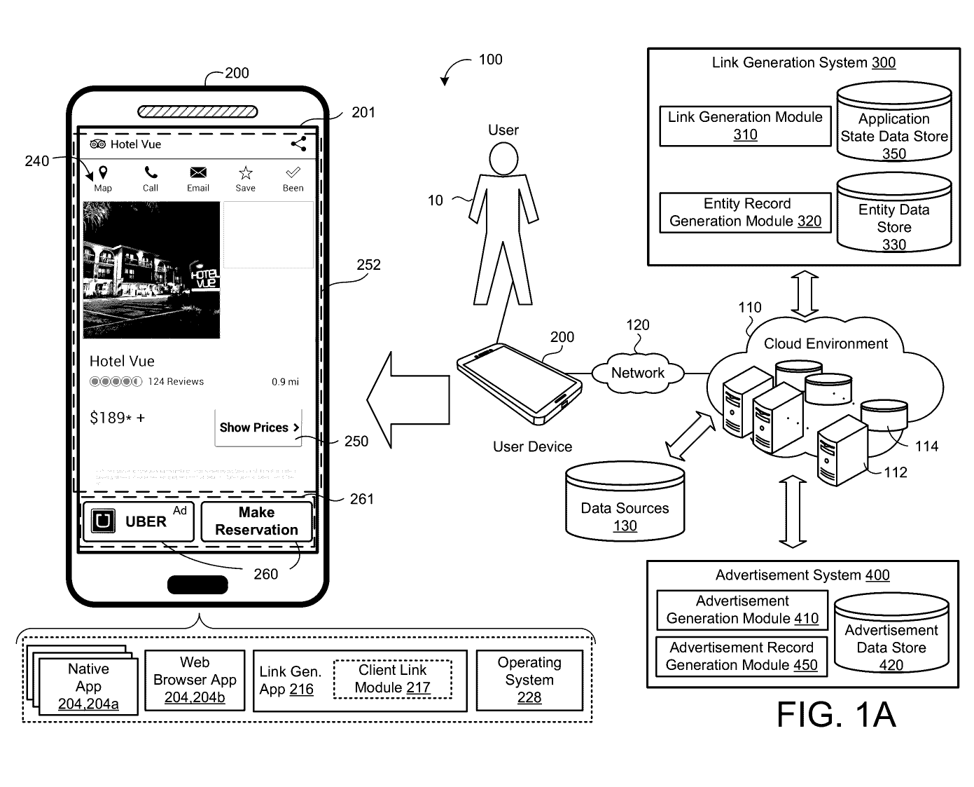

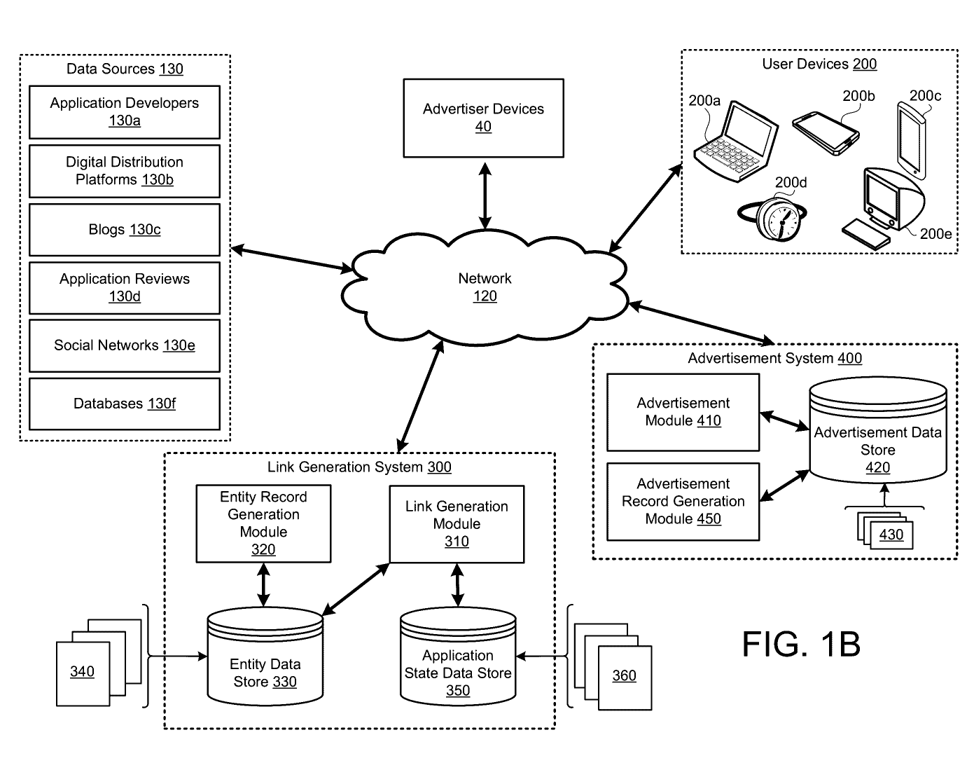

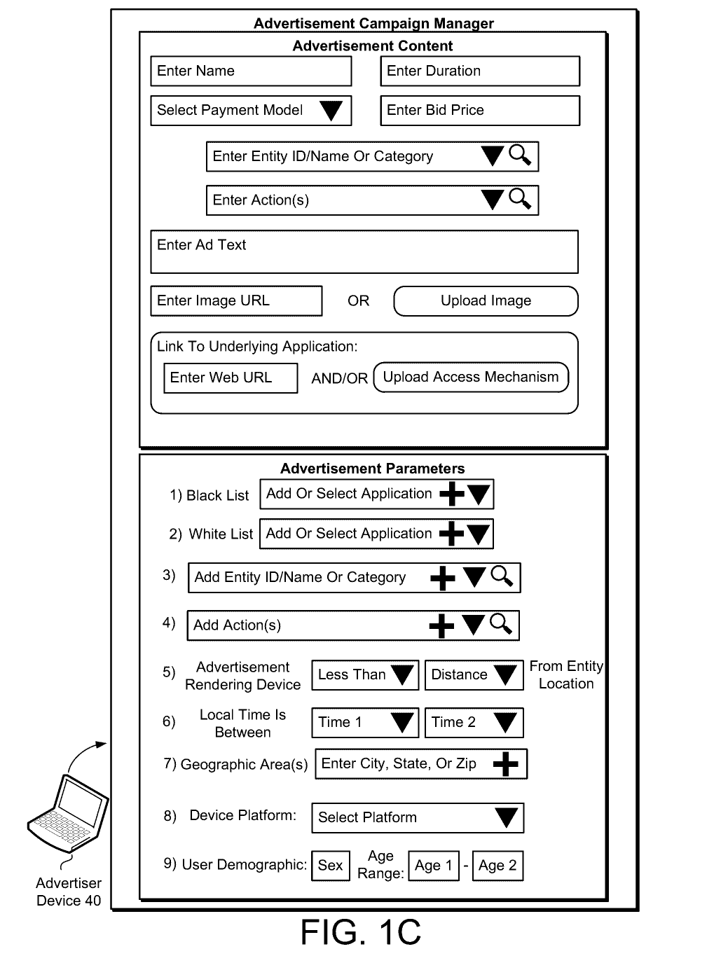

FIG. 1A illustrates an example link generation system 300, an example advertisement system 400, and an example user device 200 according to the present disclosure. In FIG. 1A, a travel application (e.g., the application TRIPADVISOR®, developed by TripAdvisor, Inc.) includes an application state describing a hotel (e.g., Hotel Vue). The user device 200 may transmit a link request to the link generation system 300 based on the currently accessed application state 252. For example, the user device 200 can transmit a link request that indicates an entity and action of the current application state 252. The currently accessed application state 252 (hereafter “current application state” 252) illustrated in FIG. 1A includes a link 250 to the action “show prices” that, when selected by a user, causes the user device to display a list of prices to stay at a particular hotel (e.g., Hotel Vue). In this example, the entity indicated by the link request is Hotel Vue and the action indicated by the link request is “show prices.” Based on this entity and action, the link generation system 300 can provide state links 260 to application states associated with the same entity but different actions. In some examples, the link generation system 300 can additionally leverage the advertisement system 400 to identify state links 260 associated with advertisement opportunities. In these examples, the link generation system 300 may include a state link 260 to a sponsored application state (i.e. an advertised state link 260) instead of a non-advertised state link 260. More specifically, as depicted by the example of FIG. 1A, the link generation system 300 provides state links 260 that allow a user of the user device to get a ride using the UBER® transportation application to Hotel Vue and/or to make a reservation at Hotel Vue, both of which are actions that the user could not otherwise access in the current application state. In this way, the link generation system 300 allows users to access related actions for Hotel Vue and provides the advertisers/developers of the UBER® and TRIPADVISOR® applications the opportunity to generate revenue.

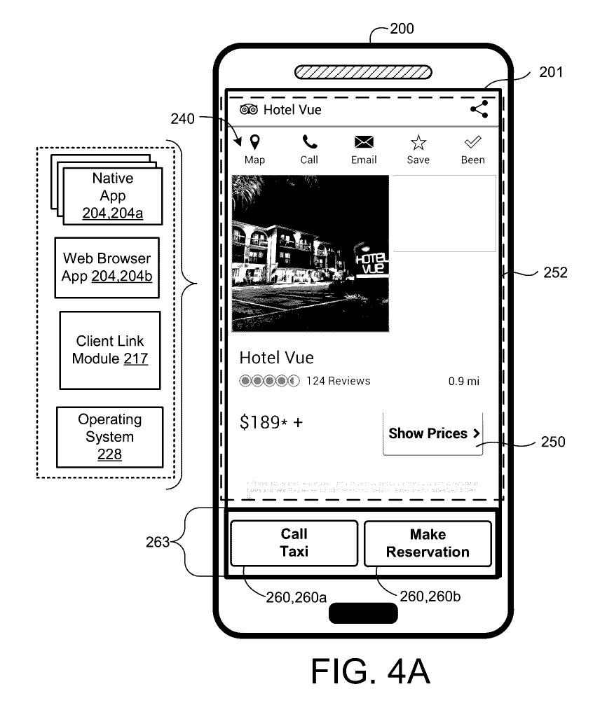

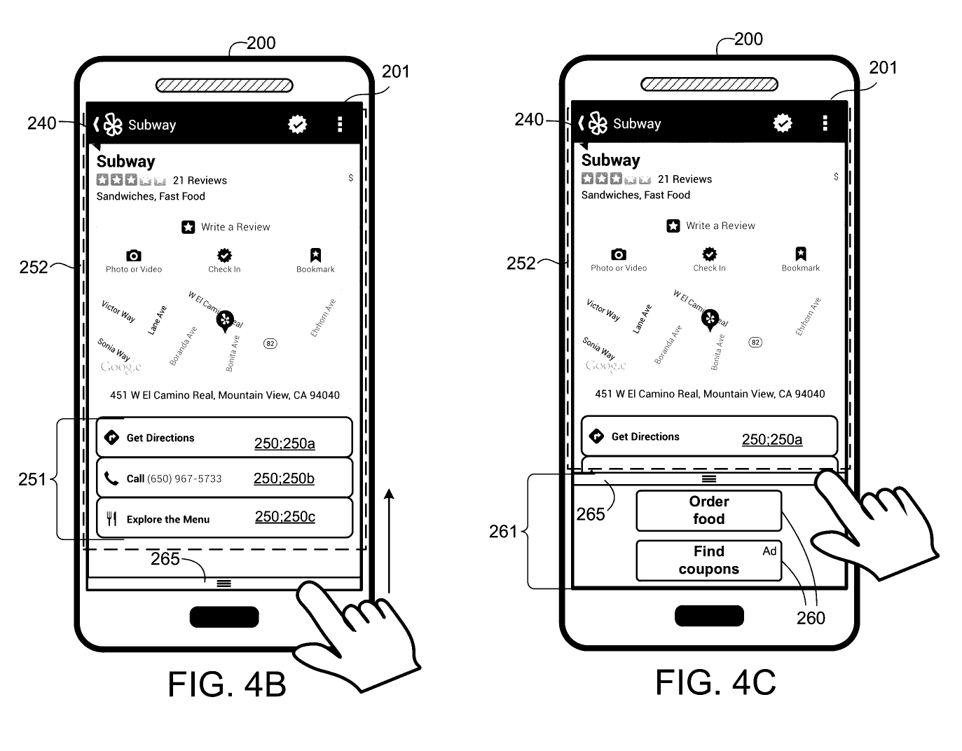

The user device 200 includes a client link module 217 configured to communicate with the link generation system 300. In some examples, the client link module 217 may be a component of a native application 204. In these examples, a developer of a native application 204 may utilize a software development kit (SDK) to implement a client link module 217 as part of their application. In these examples, the client link module 217 may execute within (e.g., as a part of) a native application 204 (e.g., a link generation application 216). In other examples, the client link module 217 may execute separately from native applications 204 installed on a user device 200. For example, an application launcher (hereafter “launcher”) may include a client link module 217 configured to communicate with the link generation system 300 separately from native applications installed on the user device. A launcher may be a program that helps users locate, launch, navigate through, and organize applications on a user device. In some examples, a launcher may serve as an interface between a user and an operating system, such as by providing a graphical user interface that allows the user to access applications and functionality of the operating system. In examples where a launcher includes the client link module 217, the client link module 217 may run in the background (e.g., execute on the user device 200 but not be displayed graphically) and provide state links 260 in response to certain events (e.g., a user swipe upwards from the bottom of the user device's display, causing an overlay containing state links 260 to appear as illustrated in FIGS. 4B-4C).

The link generation system 300 communicates with an advertisement system 400 in order to include advertisements (e.g., advertised state links 260) in a set of link results. The link generation system 300 generates an advertisement request based on data related to a current application state 252. For example, the advertisement request may include an entity and action of the current application state 252. The link generation system 300 transmits the advertisement request to the advertisement system 400. The advertisement system 400 generates advertisement results including data that the link generation system 300 may utilize to include advertised state links 260 in a set of link results. The advertisement system 400 uses the information contained in the advertisement request to identify potential advertised state links 260 (hereafter “potential advertisements”) and generate corresponding advertisement results. The advertisement results include data and information that the link generation system 300 can use to generate one or more advertised state links 260 for display within or alongside an application state. In some implementations, the advertisement system 400 may select between potential advertisements based on settings and preferences indicated by their corresponding advertisement campaigns (discussed in more detail herein).

The advertisement system 400 receives an advertisement request from the link generation system 300. The advertisement request may include an entity and an action associated with an application state. For example, the advertisement request may include the entity and action associated with an application state being accessed by a user device 200 that transmitted a link request to the link generation system 300. In some implementations, the advertisement request may additionally include an advertisement request number indicating a quantity of requested advertisements (e.g., a request for three advertised state links). The advertisement system 400 generates advertisement results including advertised state links 260 that are associated with the same entity and different actions than those of the advertisement request. In some implementations, the advertisement request may additionally or alternatively include information related to a set of link results, such as data indicating one or more potential state links 260. In these implementations, the advertisement system 400 may determine whether any of the potential state links 260 indicated by the advertisement request represent an advertisement opportunity. More specifically, the advertisement system may configure the advertisement results to indicate which of the state links 260 are associated with an advertisement campaign. In this way, the link generation system 300 may leverage the advertisement system 400 to identify state links 260 that satisfy a link request and also generate revenue by virtue of being associated with an advertisement campaign. For example, the link generation system can include advertised state links 260 in link results when there would otherwise would have been other, non-advertised state links returned in the link results.

In some scenarios, the advertisement system 400 may identify more potential advertisements than requested by the link generation system 300. In these scenarios, the advertisement system 400 may select between potential advertisements based on a number of factors. In some examples, the advertisement system 400 may select potential advertisements based on at least one of a likelihood that a user will click on a potential advertisement, an expected revenue from displaying a potential advertisement, a measure of relevance of a potential advertisement to an application state, and an amount an advertiser is willing to pay in exchange for displaying a potential advertisement. In other examples, the advertisement system 400 may generate scores for the potential advertisements indicating the relevance or popularity of the potential advertisements. In examples where the advertisement system 400 generates a score (e.g., a result score or a popularity score), the advertisement system 400 may select the potential advertisements with the highest scores.

An advertiser may communicate with the advertisement system 400 (e.g., using a campaign manager of FIG. 1C) in order to provide advertisement data related to the advertiser's sponsored application states. The advertisement data may be input into a campaign manager in order to manage and update the settings and preferences of an advertisement campaign. An advertisement campaign may detail the settings, preferences, and manner in which an advertiser's advertised state links 260 should be selected and displayed. Advertisement data associated with an advertisement campaign may include, but is not limited to, entities of an advertised application state, actions of an advertised application state, a bid price (e.g. an amount of money), and how a participating advertiser is willing to pay for their application state to be advertised. For example, an advertisement campaign may detail a payment model for an advertisement, such as a cost per impression (CPM), cost per click (CPC), or cost per action (CPA) payment model. In another example, an advertisement campaign may additionally indicate application(s) and/or sets of one or more application state(s) with which an advertiser may or may not want their advertised application state to appear alongside (e.g., a “whitelist” or “blacklist”). In one example, an advertisement campaign may indicate the geographic locations in which an advertiser wants their advertised application state to appear. As another example, an advertisement campaign may include a list of specific allowable (or disallowed) actions. For example, an advertiser for a specific restaurant application may not want to include links to third party applications for the action “view food photos” but may allow links to third party applications for the action “make reservations.” A campaign manager of the present disclosure is contemplated to additionally or alternatively include a number of other preferences and settings related to the advertisement of application states.

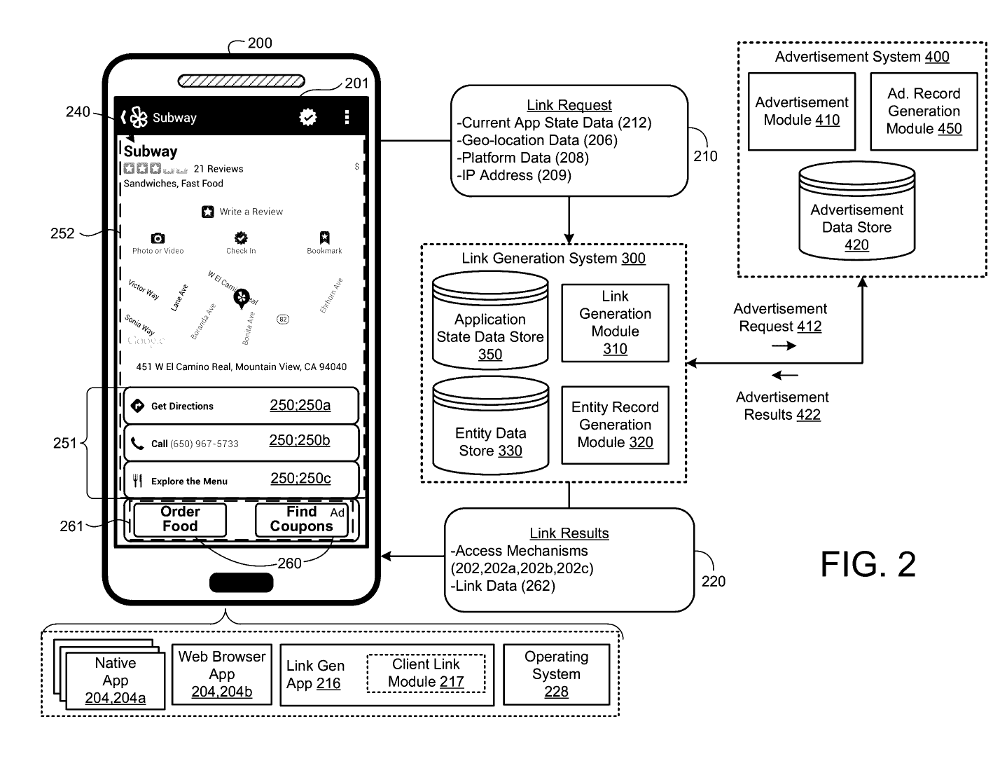

FIG. 2 illustrates an example link generation system 300 in communication with a user device 200 and an advertisement system 400. The link generation system 300 may include a link generation module 310, an entity record generation module 320, and an entity data store 330. In some implementations, the link generation system 300 may additionally include an application state data store 350 (e.g., FIG. 1B). The application state data store 350 and the entity data store 330 may include one or more databases, indices (e.g., inverted indices), tables, files, or other data structures, which may be used to implement the techniques of the present disclosure.

The link generation system 300 receives a link request 210 from a user device 200 and generates link results 220 (e.g., link data 262 and corresponding access mechanisms 202). The link request 210 may include current application state data 212 describing the current application state 252 being accessed by the user device 200. For example, current application state data 212 may include an entity and action of a current application state 252. The link generation module 310 may retrieve an entity record 340 from entity data store 330 based on the entity associated with the current application state data 212. For example, in FIG. 2, the link generation module 310 may determine that the SUBWAY® restaurant entity is associated with the application state 252. The retrieved entity record 340 may indicate application states that are associated with the same entity as the current application state 252 of the link request 210. In the example depicted by FIG. 2, the retrieved entity record 340 may indicate application states that provide actions for the SUBWAY® restaurant entity, such as “order food” and “find coupons.” The link generation system 300 may select one or more of the application states indicated by the retrieved entity record that are associated with a different action than the current application state 252 for inclusion in the link results 220. The link generation module 310 generates link results 220 including access mechanisms 202 and link data 262 that allow the user device 200 to render and display state links 260.

In some implementations, the link generation module 310 may additionally access the application state data store 350 to retrieve application state records 360 corresponding to the application states indicated by the retrieved entity record. In this way, the link generation module 310 may include data in the link results 220 that may not exist in the retrieved entity record. For example, the link generation module 310 may extract text (e.g., a slogan), images (e.g., a logo), and other data from an application state record 360 that may be used to render and display a state link 260.

The link generation module 310 may communicate with an advertisement system 400 in order to include advertisements (e.g., advertised state links 260) in the link results 220. In these implementations, the link generation module 310 transmits an advertisement request 412 to the advertisement system 400 (e.g., the advertisement module 410) and receives advertisement results 422 in return. Advertisement results 422 may include data related to an application state and its corresponding advertisement campaign. In some implementations, the advertisement results 422 may include data transmitted by an advertiser to the advertisement system 400. For example, the advertisement results 422 may include text, symbols, and/or images that an advertiser wishes to be displayed in their advertised state links 260, such as a logo of the underlying application or a screenshot of the underlying application state. In some implementations, advertisement results 422 may indicate which state links 260 in a set of one or more state links 260 are associated with an advertisement campaign. The link generation module 310 generates link results 220 based on the data of the retrieved entity record 340, one or more application state records 360, and the received advertisement results 422. The link generation module 310 configures the link results 220 to be capable of render and display by the user device 200 as user-selectable state links 260. References to state links 260 herein may generally refer to both advertised and non-advertised state links 260 unless explicitly denoted otherwise (e.g., “advertised state link 260” or “non-advertised state link 260”).

FIG. 1A illustrates an example environment 100 that includes a user device 200 associated with a user 10 in communication with a remote system 110 via a network 120. FIG. 1B provides a functional block diagram of the environment 100. The remote system 110 may be a distributed system (e.g., cloud environment) having scalable/elastic computing resources 112 and/or storage resources 114. The user device 200 and/or the remote system 110 may execute a link generation system 300, and optionally receive data from one or more data sources 130. In some implementations, the link generation system 300 communicates with one or more user devices 200 and the data source(s) 130 via the network 120. The network 120 may include various types of networks, such as a local area network (LAN), wide area network (WAN), and/or the Internet.

FIGS. 1A and 2 show an example user device 200 in communication with the link generation system 300. User devices 200 can be any computing devices that are capable of providing current application state data 212 in a link request 210 to the link generation system 300. User devices 200 include, but are not limited to, mobile computing devices, such as laptops 200a, tablets 200b, smart phones 200c, and wearable computing devices 200d (e.g., headsets and/or watches). User devices 200 may also include other computing devices having other form factors, such as desktop computers 200e, vehicle computing devices, gaming devices, televisions, or other appliances (e.g., networked home automation devices and home appliances).

User devices 200 may use a variety of different operating systems 228. In examples where a user device 200 is a mobile device, the user device 200 may run an operating system 228 including, but not limited to, ANDROID® developed by Google Inc., IOS® developed by Apple Inc., or WINDOWS PHONE® developed by Microsoft Corporation. In an example where a user device 200 is a laptop or desktop computing device, the user device 200 may run an operating system 228 including, but not limited to, MICROSOFT WINDOWS® by Microsoft Corporation, MAC OS® by Apple, Inc., or Linux. User devices 200 may also access the link generation system 300 while running operating systems 228 other than those operating systems 228 described above, whether presently available or developed in the future.

A software application 204 may refer to computer software that, when executed by a computing device, causes the computing device to perform a task. In some examples, a software application 204 may be referred to as an “application,” an “app,” or a “program.” Example software applications 204 include, but are not limited to, word processing applications, spreadsheet applications, messaging applications, media streaming applications, social networking applications, and games.

A user device 200 may include a launcher. A launcher may include a set of computer-readable instructions that are executed by a user device 200 to launch and/or navigate through native applications installed on the user device 200. A launcher may be included in an operating system of a user device 200. Alternatively, a launcher may be provided by a third-party developer and can be installed by a user of the user device 200. In other words, the launcher may itself be a native application. Launching a native application may refer to retrieving computer-readable instructions corresponding to the native application from a memory of the user device 200 and executing the computer-readable instructions at a computing processor of the user device 200.

A native application 204a may refer to an application that is installed on the user device 200. In some examples, a native application 204a may be installed on a user device 200 prior to a user 10 purchasing the user device 200. In other examples, the user 10 may download and install native applications 204a on the user device 200. Native applications 204a can perform a variety of different actions for a user 10. In one example, a restaurant reservation application can make reservations for restaurants. As another example, an internet media player application can stream media (e.g., a song or movie) from the Internet. In some examples, a single native application 204a can perform more than one action. For example, a restaurant reservation application may also allow a user 10 to retrieve information about a restaurant and read user reviews for the restaurant in addition to making reservations. As another example, an internet media player application may also allow a user 10 to perform searches for digital media, purchase digital media, and generate media playlists.

The functionality of an application 204 may be accessed on the computing device on which the application is installed. Additionally, or alternatively, the functionality of an application 204 may be accessed via a remote computing device. In some examples, all of an application's functionality is included on the computing device on which the application 204 is installed. These applications 204 may function without communication with other computing devices (e.g., via the Internet). In other examples, an application 204 installed on a computing device may access information from other remote computing devices during operation. For example, a weather application 204 installed on a computing device may access the latest weather information via the Internet and display the accessed weather information to the user through the installed weather application. In still other examples, an application 204 (e.g., a web-based application 204) may be partially executed by the user's computing device and partially executed by a remote computing device. For example, a web application 204 may be an application that is executed, at least in part, by a web server and accessed by a web browser of the user's computing device. Example web applications 204 may include, but are not limited to, web-based email, online auctions, and online retail sites.

Referring to FIGS. 1A and 2, the user device 200 may communicate with the link generation system 300 using a client link module 217. In some implementations, a native application 204 may be configured to execute a client link module 217. Native applications 204 executing a client link module 217 are described herein as link generation applications 216. The functionality of the client link module 217 may be incorporated into a native application 204 using a Software Development Kit (SDK) provided by the operator of the link generation system 300. A SDK may be a set of software development tools allowing a programmer the ability to create and modify applications for a certain software package, software framework, hardware platform, computer system, video game console, operating system, or any other development platform. In this way, a link generation application 216 may implement the client link module 217 to provide state links 260 in any application state of the link generation application 216.

In other implementations, such as in FIG. 4A, the client link module 217 may execute separately from any native applications 204 on the user device. For example, the functionality of the client link module 217 may exist on the user device 200 as a standalone application or may be executed directly by the operating system 228 of the user device 200. In one example, the client link module 217 may be a launcher operating in the background (e.g., executing on the user device 200 but not being displayed graphically). In this way, the client link module 217 may provide state links 260 to any application state accessed by the user device 200.

Returning to FIG. 1A, the client link module 217 is in communication with the link generation module 300 via the network 120. The client link module 217 is configured to monitor application states of applications 204 executing on a user device 200 and to transmit a link request 210 to the link generation system 300. The client link module 217 is also configured to receive link results 220 from the link generation module 300 and display (e.g., via the GUI 240) the link results 220 as user-selectable state links 260. The client link module 217 transmits the link request 210 in response to an event. An event may be an “automatic” or “manual” event. Manual events may occur when a user intentionally manipulates the GUI 240 of an application state in order to cause transmission of a link request 210. For example, a manual event may occur (and thereby trigger a link request 210) when a user touches/clicks a button of the GUI 240 (e.g., a button labeled “request related actions”) or swipes an element of the GUI 240 (e.g., swipes the bottom of a page upwards). Manual events may also occur when a user intentionally manipulates the user device 200 physically. For example, a manual event may occur (and thereby trigger a link request 210) when a user presses a physical button on the user device or when a user shakes or tilts the user device 200. Automatic events may occur without a user's purposeful intervention and may be predefined by a system operator of the link generation system 300 and/or an application developer of a link generation application 216. For example, an automatic event may occur upon launch of an application 204 or upon scrolling through an application state. Both manual and automatic events may cause the client link module 217 to transmit a link request 210 based on a current application state 252.

The user device 200 (e.g., via the client link module 217) generates and displays user-selectable state links 260 based on link results 220 from the link generation system 300. The user-selectable state links 260 provide different actions than a current displayed application state 252. Each state link 260 may include an access mechanism 202. A user 10 may select a state link 260 by interacting with the state link 260 (e.g., touching or clicking the link). In response to selection of a state link 260, the user device 200 may launch a corresponding software application 204 (e.g., a native application 204a or a web-browser application 204b) referenced by the access mechanism 202 and perform one or more operations indicated in the access mechanism 202.

Referring to FIGS. 1A, 1B, and 2, in some implementations, the link generation system 300 includes a link generation module 310, an entity record generation module 320, an entity data store 330, and an application state data store 350. The link generation module 310 can receive a link request 210 and generate link results 220 based on data included in the entity data store 330 and the application state data store 350.

A link request 210 includes current application state data 212 that identifies a current application and application state being displayed by the GUI 240 of the user device 200. The current application state data 212 may include an entity of the current application state 252 and one or more actions of the current application state 252. In some implementations, the current application state data 212 may include a unique identifier that identifies the current application state (e.g., application state ID 362). In other implementations, the current application state data 212 may include an application ID 369 that identifies the application of the current displayed application state 252. In still other implementations, the current application state data 212 may include a native application access mechanism 202a. In some implementations, the current application state data 212 may include information related to the operations that caused the user device 200 to launch the currently displayed application state 252. The current application state data 212 may include other suitable information related to a state being accessed by the user device 200.

The link request 210 may include additional data along with the current application state data 212. In some examples, the link request 210 may include a “black list” or a “white list.” A black list may correspond to applications, entities, actions, and/or sets of one or more application states to which a current application state 252 may not provide state links 260. A white list may correspond to applications, entities, actions, and/or sets of one or more application states to which a current application state 252 may provide state links 260. For example, the link request 210 may include a black/white list of applications and/or sets of one or more application states. In these examples, the list of applications may indicate applications to which a developer associated with the current application state 252 may not want to include state links (e.g., a “black list” of applications to which a developer does not want state links). Additionally or alternatively, the list of applications may indicate applications to which the state links may provide access (e.g., a “white list” in the scenario where a developer associated with the current application state 252 only wants to include state links to other specific applications). In some implementations, an application developer or a third party associated with an application may provide a black/white list to a system operator of the link generation system 300 separately from a link request 210 (e.g., in advance of the link request). In this way, the link generation system 300 may store data related to the black and/or white lists and provide link results accordingly.

In some implementations, the link request 210 may include a number of requested state links 260. For example, the link request 210 may request a specific number of state links or a minimum/maximum number of state links 260. In some examples, the link request 210 may request state links 260 that perform a specific action or actions. For example, the link request 210 may request state links 260 associated with the “make reservation” action. In some examples, the link request 210 may include geo-location data 206 that indicates a location of the user device 200, such as latitude and longitude coordinates. The user device 200 may include a global positioning system (GPS) receiver that generates the geo-location data 206 transmitted in the link request 210. The link request 210 may also include an IP address 209, which the link generation module 310 may use to determine the location of the user device 200. In some examples, the link request 210 may also include additional data, including, but not limited to, platform data 208 (e.g., version of the operating system 228, device type, and web-browser version), an identity of a user 10 of the user device 200 (e.g., a username), partner specific data, and other data.

The link generation module 310 receives the current application state data 212 and identifies other application states that are associated with the same entity as the current displayed application state 252, but perform different actions than the current displayed application state 252. The link generation module 310 identifies application states by accessing the application state data store 350 and the entity data store 330. In some implementations, the link generation module 310 may retrieve an application state record 360 from the application state data store 350 based on data included in the current application state data 212 (e.g., an access mechanism 202 or application state ID 362). The link generation module 310 may identify an entity indicated by the retrieved application state record 360 and retrieve a corresponding entity record 340 from the entity data store 330. In some implementations, the link generation module 310 may retrieve an entity record 340 from the entity data store 330 based on data included in the link request 210 (e.g., an entity indicated by the current application state data 212). In some implementations, the link generation module 310 may additionally or alternatively retrieve one or more application state records 360 from the application state data store 350 based on the retrieved entity record 340.

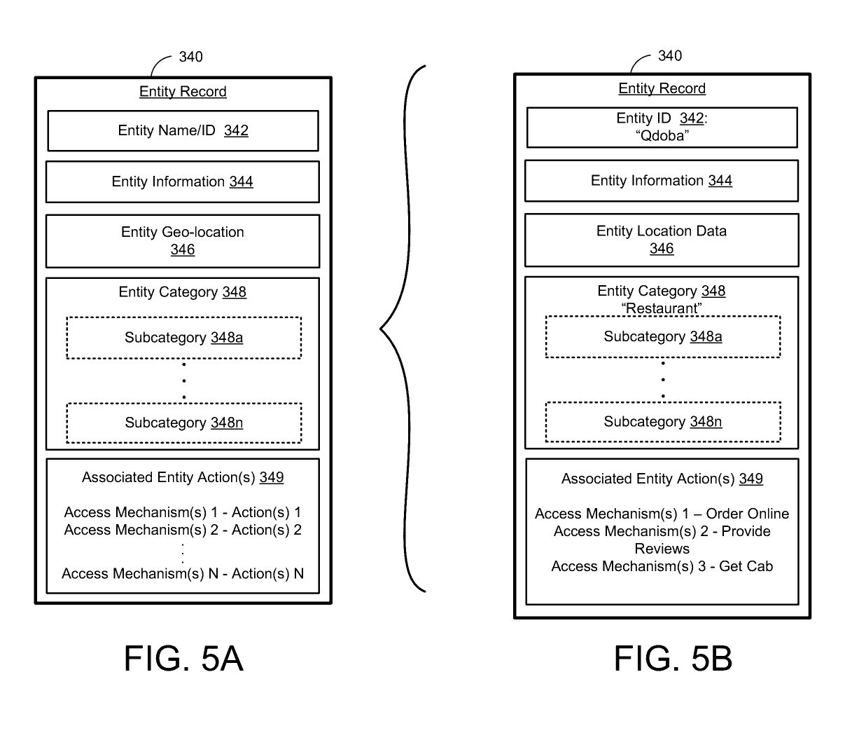

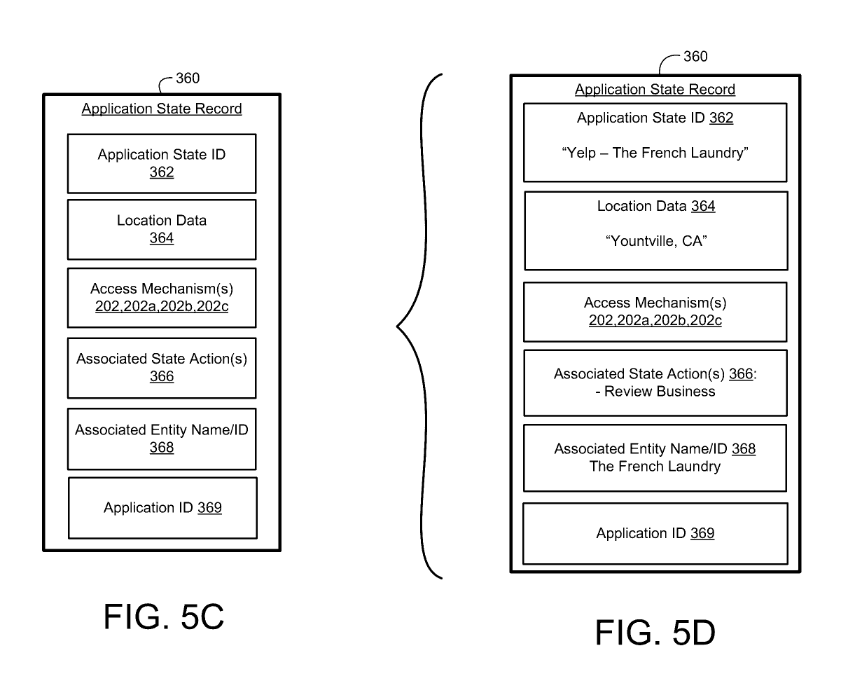

The retrieved entity record 340 (FIGS. 5A and 5B) may include data related to its corresponding entity (i.e., the entity of the link request 210) such as entity information 344 and data related application states corresponding to the entity (e.g., access mechanisms 202). In some implementations, the application state records 360 retrieved by the link generation module 310 may correspond to the application states indicated by the entity record 340 and may also include one or more access mechanisms 202. In addition, each application state record 360 includes additional information relating to its corresponding application state (discussed below with respect to FIGS. 5C and 5D). The link generation module 310 may utilize the data included in the entity records 340 and application state records 360 to generate link data 262 to be included in the link results 220. The link generation module 310 may additionally include access mechanisms 202 from the retrieved records 340, 360 corresponding to the generated link data 262 in the link results 220.

In some implementations, the link generation module 310 may identify more application states than requested by the link request 210. The link generation module 310 may select between identified application states in a variety of ways. In one example, the link generation system 300 may leverage the advertisement system 400 to select the identified application states that may generate revenue. More specifically, the link generation system (e.g., via the link generation module 310) may generate an advertisement request 412 that indicates the identified state links to the advertisement system 400. In this example, the advertisement system 400 may return advertisement results 400 that indicate which of the identified state links 260 present advertisement opportunities, which the link generation system 300 may then select for display to a user instead of a non-advertised state link.

The link generation module 310 may select between identified application states based on criteria other than advertisement opportunities. For example, the link generation module 310 may select between identified application states based on relevance scores and/or data included in the link request 210. In some examples, the link generation module 310 may generate a relevance score 226 indicating the relative relevance of an identified application state. For example, the link generation module 310 may perform text-based matching between the contents of the link request 210 and the retrieved records 340, 360 corresponding to the identified application states. In this example, the link generation module 310 may grant larger relevance scores 226 to identified application states with a higher percentage of text matches, and lower relevance scores 226 to identified application states with a lower percentage of text matching.

The link generation module 310 may additionally or alternatively select between identified application states based on data included in the link request 210. For example, the link generation module 310 may filter out identified application states based on additional data included in the link request 210 such as a requested action, a requested application, and/or geo-location data. In these examples, the link generation module 310 may filter out application states that do not satisfy the additional data of the link request 210. For example, the link generation module 310 may filter out identified application states corresponding to an entity outside of a specified distance of the geo-location in the link request 210. In another example, the link generation module 310 may filter out application states that do not match the requested action or requested application of the link request 210. In some examples, the link generation module 310 may filter out application states to include based on a predefined list of applications corresponding to the current application state 252. For example, an application developer associated with the current application state 252 may provide a list of acceptable (or unacceptable) software applications to which any state links 260 appearing in the current state 252 may (or may not) correspond. In a similar example, a system operator of the link generation system 300 may define a similar list of applications or application states that may or may not be provided by the link generation module 310 in response to particular current application states 252.

FIG. 1B illustrates an example advertisement system 400 that includes an advertisement module 410, an advertisement record generation module 450, and an advertisement data store 420. The advertisement system 400 receives an advertisement request 412 from the link generation system 300 and returns advertisement results 422. The advertisement record generation module 450 generates advertisement records 430 based on advertisement data included in one or more advertisement campaigns. Advertisement campaigns may be created and updated by advertisers (e.g., a developer of an application, an owner of an application, and/or a third party hired to advertise an application/entity). The advertisement module 410 generates advertisement results 422 based on the advertisement request 412. For example, the advertisement module 410 may retrieve advertisement records 430 and then generate advertisement results 422 based on an advertisement request 412 and the retrieved advertisement records 430.

The advertisement record generation module 450 communicates with advertiser devices 40 via an advertisement campaign manager (e.g., FIG. 1C). The advertisement system 400 (e.g., via the advertisement record generation module 450) may provide the advertisement campaign manager to the advertiser devices 40. The advertiser devices 40 can use the advertisement campaign manager to generate advertisement records 430 that are stored in the advertisement data store 420.

FIG. 1C illustrates an example campaign manager rendered on an advertiser device 40. The campaign manager may be configured to receive advertisement data from an advertiser device. The input fields and appearance of the campaign manager illustrated by FIG. 1C is for example purposes only. It is contemplated that a campaign manager may include additional or alternative fields other than those illustrated in FIG. 1C. Accordingly, it is contemplated that other suitable input fields and/or other GUI elements may be included in the campaign manager of FIG. 1C.

The advertisement record generation module 450 generates an advertisement campaign manager that can be rendered and displayed as a GUI (FIG. 1C) on an advertiser device 40. An advertiser can use an advertiser device 40 (e.g., a computing device connected to the Internet) to provide advertisement data such as settings, preferences, and any other suitable details pertaining to the manner in which advertisements associated with the advertiser's application should be displayed. In some implementations, the advertisement record generation module 450 may provide data to an advertiser device 40 (e.g., via the Internet) that the advertiser device 40 may utilize to render a GUI for the advertisement campaign manager. In some implementations, the advertisement system 400 may provide an application for installation on an advertiser device 40. In these implementations, the application may be configured to render a GUI for the advertisement campaign manager and to communicate with the advertisement system 400. The advertisement record generation module 450 may generate advertisement records 430 based on the advertisement data (e.g., settings, preferences, and other details) input into the advertisement campaign manager by the advertiser. Advertisement records may refer to any suitable data structures that the advertisement record generation module 450 may generate based on the advertisement data received from the advertisers via the campaign manager. In response to a received advertisement request 412, the advertisement module 410 can retrieve advertisement records 430 and utilize the advertisement records 430 to generate advertisement results 422.

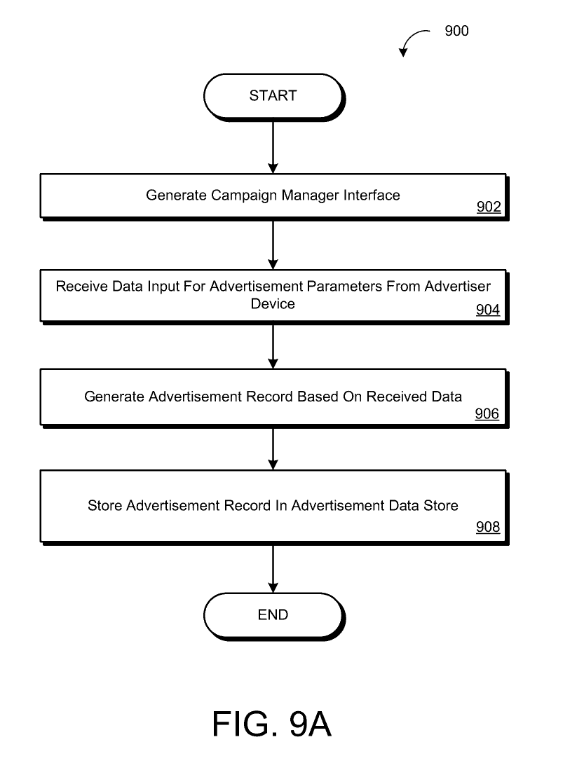

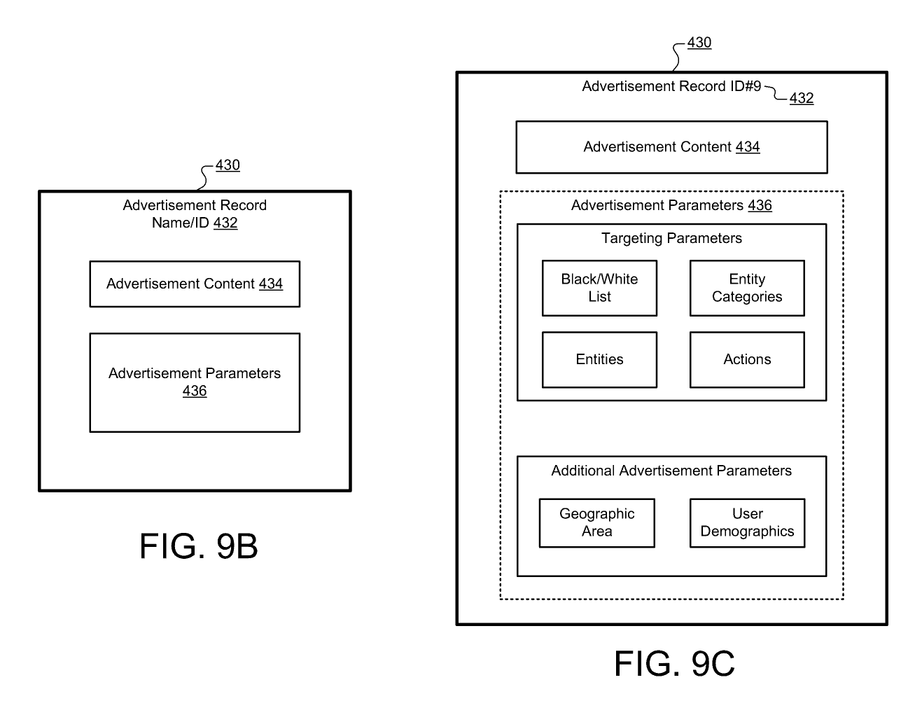

FIGS. 9B and 9C illustrate an example advertisement record 430. An advertisement record 430 may include a variety of different types of data related to an advertisement. An advertisement record 430 may include data that uniquely identifies the advertisement record 430. For example, the advertisement record 430 may include an advertisement name and/or an advertisement identifier 432 (i.e., “advertisement ID”) that identifies the advertisement record 430 among the different advertisement records 430 in the advertisement data store 420.

An advertisement record 430 may also include advertisement content 434. Advertisement content 434 may include data used by the advertisement system 400 to generate advertisement results 422. For example, advertisement content 434 may include text associated with the underlying application/link of a potential advertisement, such as a name of the developer of the underlying application. The advertisement content 434 may also include images (e.g., images to be displayed in the state links), such as an application icon (e.g., an icon for the UBER® application of FIG. 1A). An application icon may be an image that represents the application. An image may also include screenshots or previews of the underlying application/state. The advertisement content 434 may also include links to locations from which the underlying application may be downloaded. For example, the advertisement content 434 may include hyperlinks to one or more digital distribution platforms from which the underlying application may be downloaded.

An advertisement record 430 may include advertisement parameters 436. Advertisement parameters 436 may define budgets associated with advertising, timing parameters associated with advertising (e.g., start and stop dates), and a variety of different types of targeting parameters. A targeting parameter may refer to a condition that should be satisfied before the advertisement system 400 generates an advertisement. Example types of targeting parameters may include, but are not limited to, a “black list” targeting parameter (e.g., a list of applications and/or sets of one or more application states with which an advertisement should not appear), a “white list” targeting parameter (e.g., a list of the only applications and/or sets of one or more application states with which an advertisement should appear), entity targeting parameters (e.g., a list of entity names or entity categories of a currently displayed application state 252), action parameters (e.g., a list of actions of a currently displayed application state 252). A targeting parameter in the form of a black/white list indicating sets of one or more application states may indicate application states of a particular application that follow a particular path. For example, an advertiser may want to target or avoid application states of a movie review application related to children's movies (e.g., G-rated).

An advertiser may use an advertiser device 40 to input advertisement data using a campaign manager that corresponds to the fields of an advertisement record 430. In this way, an advertiser can provide advertisement data about their advertised application that the advertisement system 400 may use to populate the advertisement content 434 and advertisement parameters 436 of an advertisement record 430.

In some implementations, an advertiser may utilize an advertisement campaign manager to specify advertisement parameters 436 such as entity names, entity categories, or actions of a currently displayed application state 252 that trigger the display of the advertiser's advertised state link 260 within or alongside the currently displayed application state 252. For example, an advertiser may create an advertisement campaign corresponding to a restaurant review application. In this example, the advertiser may identify CHIPOTLE® as an entity that triggers the inclusion of the advertiser's advertised state link 260. Additionally or alternatively, the advertiser may identify “restaurant” as the entity category that triggers the inclusion of their advertised state link(s) 260. In this way, an advertiser can broaden the scope of entities that trigger the inclusion of the advertiser's advertised state link 260 in a currently displayed application state 252. Continuing this example with respect to actions, the advertiser may identify the action “order food for delivery” as an advertisement parameter 436 that triggers inclusion of the advertiser's advertised state link 260.

In some implementations, an advertiser can use an advertisement campaign manager to provide targeting parameters in the form of a list of applications and/or set of one or more application states with which the advertiser's advertised state links 260 should not appear (e.g., a “black list”). Additionally or alternatively, an advertiser can indicate a list of applications and/or set of one or more application states that the advertiser's advertised state links 260 should appear in (e.g., a “white list”).

In some implementations, an advertiser may input advertisement data into a campaign manager that specifies individual application states to advertise. In other implementations, an advertiser may allow the advertisement system 400 and/or the link generation system 300 to determine the application state(s) to advertise (e.g., based on a relevance score, discussed herein). For example, an advertiser of the OPENTABLE® application may indicate to the advertisement system 400 that it may generate advertisements for application states of the OPENTABLE® application that allow a user to make reservations at a restaurant. In another example, an advertiser of the IMDB® application may indicate to the advertisement system 400 that it may generate advertisements for the application states of the IMDB® application.

In some implementations, an advertiser may utilize a campaign manager to specify other advertisement parameters 436 such as a bid price and a payment model. In one example, an advertiser can opt for a cost-per-impression (CPM) payment model, whereby the advertise pays the specified bid price whenever the advertiser's advertised state link(s) 260 are displayed. In another example, an advertiser can opt for a cost-per-click (CPC) payment model, whereby the advertiser pays the specified bid price whenever the advertiser's state link 260 is selected (e.g., tapped/clicked on). In another example, an advertiser can opt for a cost-per-action (CPA) payment model, whereby the advertiser pays the specified bid price whenever a user engages with the advertiser's state link 260 in a specific way (e.g., a user completes a transaction or installs an application the user was led to by the advertised state link 260).

In some implementations, an advertiser may utilize a campaign manager to provide a plurality of additional targeting parameters. For example, the advertiser may specify a geographic area in which the advertisement should appear, a time of day that the advertisement should appear, and/or physical conditions in which the advertisement should appear (e.g., when device movement indicates that the user is in a vehicle). Additional examples of targeting parameters include, but are not limited to, user demographics of the users to whom the advertisement should appear, a device platform of the devices on which the advertisement should appear, an installation status of an application for which the advertisement should appear, and any other suitable parameters related to the underlying application of the advertiser's advertised state link 260.

An advertiser may also use a campaign manager to provide advertisement data corresponding to the advertisement content 434 of an advertisement record 430. For example, the advertiser may provide an application name, an image of an application logo or other images related to an application, application access mechanisms and web access mechanisms for an application, text describing the application/state, or any other suitable information related to the advertised application/state. In some implementations, the campaign manager may provide preview functionality that illustrates an example of how the advertised state links 260 will be displayed based on the available advertisement content 434.

In some implementations, an application developer or third party associated with a software application may interact with the advertisement system 400 via a campaign manager to specify advertised state links 260 that are allowed or not allowed to be included alongside application states of their application. Application developers (or third parties associated with application developers) may specify (e.g., via a campaign manager) several other settings and preferences with regard to advertisements displayed with their application states. For example, an application developer may specify a list of actions, a maximum number of allowed advertisements, the position of advertisements (e.g., a location on an application state where advertisements are allowed to appear), a minimum expected revenue of the advertisements, a minimum relevance of popularity of the advertisements, and other settings or preferences. The advertisement system may take into account the preferences of both advertisers and application developers hosting advertisements.

In some implementations, a revenue sharing system (not shown) can be included in the environment 100 and communicate with the link generation system 300 and the advertisement system 400. The revenue sharing system may be configured to manage the sharing of revenue resulting from displaying advertised state links 260. The revenue sharing system may incentivize developers to develop and intertwine related actions. For example, IMDB® is an application that provides movie information and MovieFoneTM is an application that allows users to buy movie tickets. A user 10 may be accessing the IMDB® application and viewing a currently displayed application state 252 that provides a movie review. By leveraging the advertisement system, the link generation system 300 may configure the link results 220 to include an advertised state link 260 to a state of the MovieFoneTM application. For example, the link generation system 300 may include an advertised state link 260 that allows the user to buy tickets to the movie for which they are viewing a review. In this example, if the user buys tickets using the MovieFoneTM application, the revenue system may split the revenue generated based on an agreement between the advertisers and/or developers of the IMDB® and MovieFone™ applications. Additionally or alternatively, the revenue system may split the revenue based on the settings and preferences maintained by the advertisement system 400.

FIG. 2 depicts a link generation system 300 in communication with a user device 200 and an advertisement system 400. The link generation system 300 may communicate with the advertisement system 400 via the link generation module 310. The link generation module 310 can generate an advertisement request 412 including an entity and action of a currently displayed application state 252. In some implementations, an advertisement request 412 may include additional data related to a currently displayed application state 252, such as current application state data 212 received from a user device 200. The current application state data 212 may include, but is not limited to, an application access mechanism 202, an application state ID 362, an entity, and/or one or more actions of a currently displayed application state 252.

In some implementations, the link generation module 310 may additionally include data related to a set of link results 220 (e.g., application state IDs, entities, actions, and any other information related to a set of link results 220) in the advertisement request 412. In these examples, the link generation module 310 may utilize received advertisement results 422 to determine whether any of the link results 220 (which may already be prepared to be displayed as non-advertised state links 260) present advertisement opportunities. In other words, the advertisement results 422 may indicate to the link generation module 310 that one or more of the link results 220 are associated with an advertisement campaign (e.g., the underlying application state appears in an advertisement record 430). In these examples, the link generation module 310 may modify the link results 220 to include a subset of link results 220 that are associated with an advertisement campaign. In this way, the link generation module 310 may prioritize state links 260 capable of generating revenue. For example, with respect to FIG. 2, the link generation module 310 may include data with respect to several potential state links 260 in the advertisement request 412. One such potential state link 260 may navigate a user to an application state that allows the user to perform the action “Find Coupons.” In this example, the advertisement results 422 indicate to the link generation module 310 that the potential state link 260 to the “Find Coupons” action presents an advertisement opportunity. Based on this indication, the link generation module 310 includes the advertised state link 260 for the “Find Coupons” application state in the link results 220 over other, non-advertised state links 260.

In some implementations, an advertisement request 412 may include an advertisement request number indicating a quantity of requested advertisements (e.g., five advertised state links 260), in addition to an entity and action of a currently displayed application state 252. In these implementations, the link generation module 310 may include the specified number (e.g., indicated by the advertisement request number) of advertised state links 260 in a set of link results 220 despite generating non-advertised state links 260. In this way, a user device 200 may display an advertised state link 260 in an application state 252 in which it may not otherwise appear. For example, the currently displayed application state 252 of FIG. 1A includes an advertised state link 260 to an UBER® application state and a non-advertised state link 260 to an application state that allows the user to make a reservation. In this example, the link generation module 310 may have had the opportunity to select other, non-advertised state links 260 instead of the advertised state link 260 for the UBER® application state. For example, the link generation module 310 may have selected a non-advertised application state link 260 to an application state of a hotel review application. More specifically, there may be N (where N is greater than one) non-advertised state links 260, several of which may be more popular or relevant than the advertised state link 260 for the UBER® application state. This technique allows an advertised state link 260 the opportunity to generate revenue by being placed in a currently displayed application state 252 where it may not otherwise appear.

The advertisement module 410 receives an advertisement request 412 from the link generation module 310, identifies advertisement records 430 based on the advertisement request 412, and transmits advertisement results 422 based on the identified advertisement records 430. In some implementations, the advertisement request 412 received by the advertisement module 410 may indicate an entity and action associated with a currently displayed application state 252. In these implementations, the advertisement module 410 identifies advertisement records 430 associated with the same entity and different action than the entity and action of the advertisement request 412. In some implementations, the advertisement module 410 can utilize additional or alternative techniques to identify advertisement records 430 in the advertisement data store 420 that satisfy the advertisement request 412. For example, the advertisement module 410 can identify potential advertised state links 260 based on text matches between terms of the advertised state links 260 corresponding advertisement records 430 and the terms of the advertisement request 412.

In some examples, the advertisement module 410 may identify more advertisement records 430 capable of satisfying the advertisement request 412 than are requested by the advertisement request 412. For example, the advertisement request 412 may request one advertisement, but the advertisement module 410 may identify ten potential advertisements. The advertisement module 410 can select between multiple potential advertisement records using a variety of techniques. In one example, the advertisement module 410 can select advertisement records 430 based on the likelihood that a user will click on an advertisement record's 430 corresponding advertised state link 260. In these examples, the advertisement module 410 can determine a percentage likelihood that a user will click on an advertised link 260 based on user usage data (e.g., user analytics). The advertisement module 410 can select the advertisement records 430 corresponding to the N-highest percentages, where N may be a number of advertisements selected for display within or alongside a currently accessed application state 252 (e.g., a number indicated by the advertisement request 412).

In another example, the advertisement module 410 can select advertisement records 430 based on a bid price associated with an advertisement (e.g., an amount to be paid in exchange for displaying a potential advertisement). In these examples, the advertisement module 410 can select the advertisement record 430 specifying the highest bid price. In another example, the advertisement module 410 can select advertisement records 430 based on a calculation of the expected revenue from displaying an advertised state link 260. In these examples, the advertisement module 410 can calculate expected revenue based on the bid price, payment model, and other information indicated by the corresponding advertisement record 430. In these examples, the advertisement module 410 can select the advertisement records 430 with the N-largest expected revenues. For example, for advertisement records 430 that indicate a cost-per-click (CPC) payment model, the advertisement module 410 can calculate expected revenue by multiplying the percentage likelihood a user will click on the corresponding advertised state links 260 with the bid price indicated by the advertisement records 430 and select the advertisement records 430 with the largest expected revenue. In a more specific example, the advertisement module 410 may select a first advertisement record 430 indicating a bid price of one cent ($0.01) over a second advertisement record 430 indicating a bid price of two cents ($0.02) if the first advertisement record 430 is five times more likely to be clicked on by a user. Similarly, in this example, the advertisement module 410 may select the first advertisement record 430 if it is much more relevant than the second advertisement record 430, as indicated by its corresponding relevance score (discussed below). Any of the techniques for selecting between advertisement records 430 discussed herein may be combined or used together as part of the advertisement record 430 selection process.

In some examples, the advertisement module 410 may generate relevance scores for the advertisement records 430 of the potential advertised state links 260. The relevance scores may indicate the relevance of the potential advertised state links' 260 underlying application states to the currently accessed application state 252. For example, the advertisement module 410 may perform text matching between terms of the advertisement records 430 and terms appearing in the currently displayed application state 252. In this example, the advertisement module 410 may assign higher relevance scores to advertisement records 430 better text matches (e.g., a greater number of matches). Similarly, the advertisement module 410 may assign lower relevance scores to advertisement records with a low concentration of text matches. In other examples, the advertisement module 410 may retrieve or generate popularity scores indicating the popularity of the potential advertised state links' 260 underlying application states. In examples where the advertisement module 410 generates or determines a score (e.g., a relevance score or a popularity score), the advertisement module 410 may select the advertisement records 430 corresponding to the N-highest scores, where N is a number of advertisements indicated by the advertisement request 412.

The advertisement module 410 generates advertisement results 422 based on the selected advertisement records 430. For example, the advertisement results 422 may be generated based on selected advertisement records 430 from a group of potential advertisement records 430, each of which corresponds to a potential advertised state link 260. In some cases, such as in the case where the link generation module 310 includes a request for a specific number of advertised state links 260 in the advertisement request 412, the advertisement module 410 may provide link data 262 such as text, images, or any other information in the advertisement results 422. For example, the advertisement module 410 can extract information from the advertisement records 430 that the link generation module 310 can utilize to generate advertised state links 260. In a specific example related to FIG. 1A, the advertisement module 410 provides link data 262 related to the UBER® application that allows the user device 200 to render and display the UBER® icon in the currently accessed application state 252.

In other scenarios, such as in the case where the link generation module 310 includes data related to several potential state links 260 in an advertisement request 412, the advertisement module 410 may include data in the advertisement results 422 indicating which of the potential state links 260 present advertisement opportunities. For example, the advertisement results may include an application state identifier 362, an application name, or other information that the link generation module 310 can utilize to locate a corresponding application state record 360 in the application state data store 350 or to identify a potential state link 260 from other potential state links 260. In these examples, the link generation module 310 may append data (e.g. text or images) to the link data 262 of an advertised state link 260 that indicates that the state link 260 is an advertisement. In this way, a user device 200 may render and display state links 260 such that a user viewing them may identify which of the state links 260 are advertised state links 260.

Depiction of the link generation system 300 and the advertisement system 400 as separate systems (e.g., separate computing systems communicating via a network 120) is intended to highlight different functional aspects of the systems 300, 400 and does not necessarily imply that such systems 300, 400 must be realized by separate computing systems. In some implementations, some of the functionality associated with the link generation system 300 can be performed by the advertisement system 400. Similarly, in some implementations, some of the functionality associated with the advertisement system 400 may be performed by the link generation system 300. In some cases, functionality associated with the link generation system 300 and the advertisement system 400 can be implemented by a single computing system or computing systems communicating in a local network, instead of a long range network, such as the Internet. In some cases the computing system(s) that implement the link generation system 300 and the advertisement system 400 may be controlled by different parties (e.g., different owners). In other cases, a single owner may implement the link generation system 300 and some, or all, of the functionality attributed to the advertisement system 400.

The entity data store 330 stores entity records 340, each associated with an entity. An entity may refer to a person, place, or thing. For example, an entity may refer to a business, product, service, media content, political organization/figure, public figure, destination, or any other suitable item of commerce, which may be advertised in connection with an application 204. For example, referring to the GUI 240 shown in FIG. 1A, the review application (e.g., TripAdvisor®) is associated with the entity “Hotel Vue.” The entity record generation module 320 may generate entity records 340 (FIGS. 5A-5B) from the data sources 130 based on an entity associated with a specific application state. An application state (e.g., accessed via an access mechanism 202) may perform actions related to an entity. For example, with respect to FIG. 1A, the current displayed application state 252 of the TRIPADVISOR® application may perform the action of “show prices” for the entity “Hotel Vue.” Each entity record 340 may include data related to an entity. In some examples, an entity can be associated with more than one application state.

In some implementations, an action ontology may be stored by the link generation system 300 in the form of a list of actions corresponding to application states. The link generation system 300 can use the action ontology to assign actions to the entity records 330 and application state records 360. For example, the link generation system 300 may include one or more modules (not shown) that can assign actions to application state records 360. As another example, the link generation system 300 may utilize the entity record generation module 310 and/or one or more modules (not shown) to assign actions to entity records. The action ontology may be defined by a system operator. In some examples, the system operator can create an action ontology specific to the link generation system 300. In other examples, the system operator may select actions from an existing ontology such as one provided by schema.org (sponsored by Google, Inc., Yahoo, Inc., Microsoft Corporation, and Yandex). In this way, actions may be assigned to application states manually and/or automatically.

In some examples, application states may be marked up (e.g., tagged) with actions by third parties (e.g., application and/or website owners/developers other than those that operate the link generation system 300). In these examples, the link generation system 300 can utilize the marked up actions to assign actions to application states. In other examples, the system operator may assign actions to application states and web pages at the application and domain level, respectively. For example, a food review application may be assigned the action “read review.” The link generation system 300 may then assign the application-level action “read reviews” across a plurality of states of the food review application automatically. In a different example, the system operator may assign actions to application states and web pages individually (e.g. a sample size of different states/pages). The link generation system 300 can then assign actions to similar states in the application/website. For example, the system operator can manually assign the action “read review” to a state/page and replicate this assignment across other states/pages at the same level in the application/website (e.g., states/pages related to reading reviews). More specifically, if the action related to the manually-assigned state/page relates to reading reviews about restaurants, any other states also related to reading reviews about restaurants may automatically be assigned the same action as the manually-assigned state/page. As another specific example, if a state/page of a movie database application/website relates to specific movie information, that state/page can be assigned the action “read movie information” manually by the system operator. The link generation system 300 may then apply the action “read movie information” across the rest of the states/pages of the movie database application/website that allow a user to view information related to a specific movie.

Example actions may include, but are not limited to: Navigate to a location, Find transportation to a location, Provide restaurant information, Order food from a restaurant, Provide food photos, Show menu, Find a business, Provide reviews of business, Provide food recipes, Send message, Check stocks, Check weather, Check sports scores, Play music, Play movie, Listen to radio station(s), Record video, Provide discount.

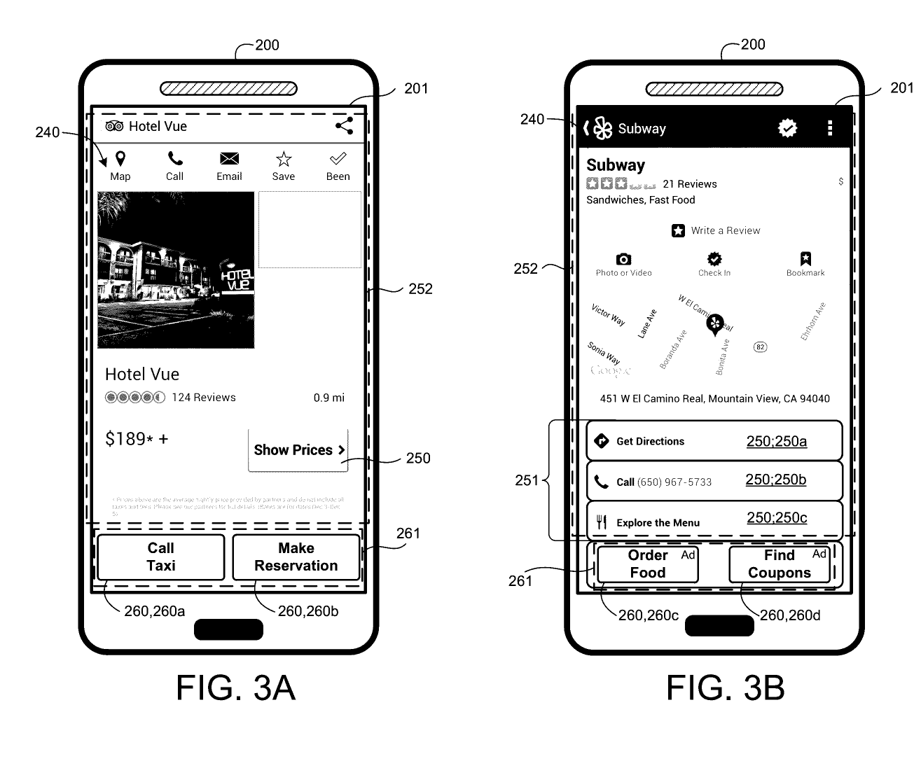

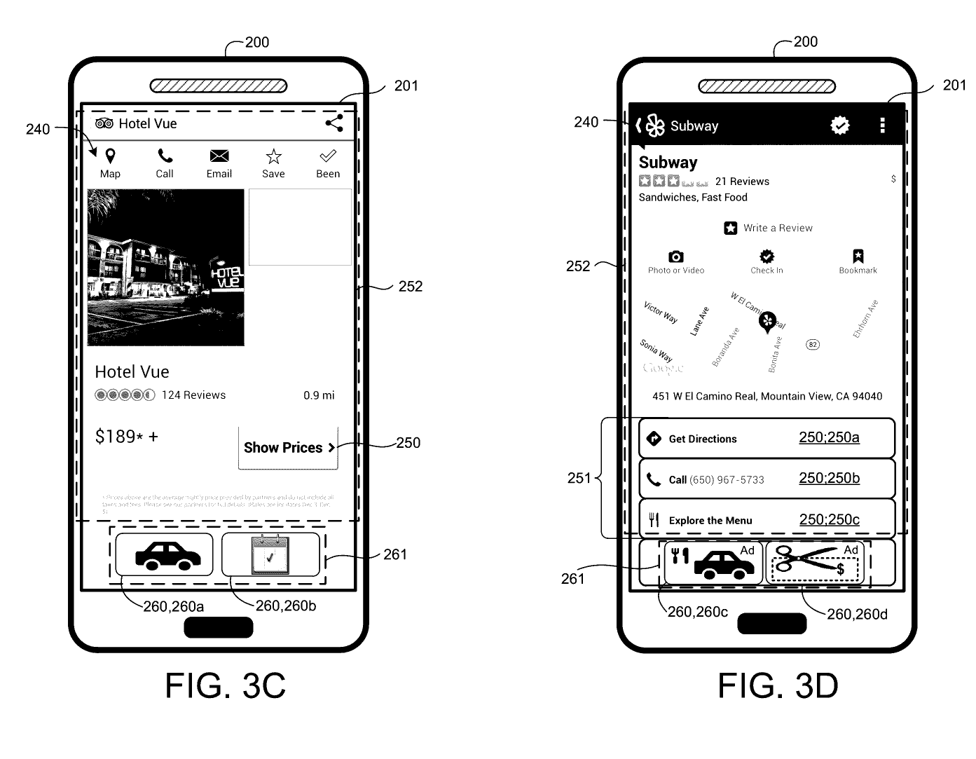

Referring to FIGS. 2-3C, the user device 200 generates and displays state links 260 based on the link results 220 received from the link generation system 300. The user device 200 may additionally display user-selectable application links 250. Application links 250 are pre-existing links in an application state that are provided by an application running on the user device 200 instead of the link generation system 300. Each of the state links 260 and application links 250 may be associated with an access mechanism 202 so that if a user 10 selects one of the state links 260 or application links 250, the user device 200 launches the underlying application and sets the application into a state that is specified by the access mechanism 202 associated with the selected link 250, 260. A user 10 may select an application link 250 or a state link 260 on the user device 200 by interacting with the link 250 or state link 260 (e.g., touching or clicking the link 250, 260). In response to selection of a link 250, 260, the user device 200 may launch a software application 204 (e.g., a native application 204a or a web-browser application 204b) referenced by the corresponding access mechanism 202 and perform one or more operations indicated in the access mechanism 202.

Access mechanisms 202 may include at least one of a native application access mechanism 202a (hereinafter “application access mechanism”), a web access mechanism 202b, and an application download mechanism 202c. The user device 200 may use the access mechanisms 202 to access actions of applications 204. For example, the user 10 may select a state link 260 or link 250 including an access mechanism 202 in order to access actions of an application 204 indicated by the state link 260. The link generation module 310 may transmit one or more application access mechanisms 202a, one or more web access mechanisms 202b, and one or more application download mechanisms 202c to the user device 200 in the link results 220.

An application access mechanism 202a may be a string that includes a reference to a native application 204a and indicates one or more operations for the user device 200 to perform. If a user 10 selects a state link 260 or link 250 including an application access mechanism 202a, the user device 200 may launch the native application 204a referenced in the application access mechanism 202a and perform the one or more operations indicated in the application access mechanism 202a.

An application access mechanism 202a includes data that the user device 200 can use to access application states provided by a native application 204a. For example, an application access mechanism 202a can include data that causes the user device 200 to launch a native application 204a and perform an action associated with the native application 204a. Performance of operations according to the access mechanism 202 may set the native application 204a into a specified state that performs an action. In some examples, an application access mechanism 202a for a restaurant reservation application can include data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews. In additional examples, an application access mechanism 202a for an internet media player application can include data that causes the user device 200 to launch the internet media player application and stream media from the Internet. In such examples, the internet media player application may be set in a state that displays information regarding the media (e.g., music) being streamed, such as a song name, an artist, or an album name.

Application access mechanisms 202a may have various different formats and content. The format and content of an application access mechanism 202a may depend on the native application 204a with which the application access mechanism 202 is associated and the operations that are to be performed by the native application 204a in response to selection of the application access mechanism 202a. For example, an application access mechanism 202a for an internet music player application may differ from an application access mechanism 202a for a shopping application. An application access mechanism 202a for an internet music player application may include references to musical artists, songs, and albums, for example. The application access mechanism 202a for an internet music player application may also reference operations, such as randomizing a list of songs and playing a song or album. An application access mechanism 202a for a shopping application may include references to different products that are for sale. The application access mechanism 202a for the shopping application may also include references to one or more operations, such as adding products to a shopping cart and proceeding to a checkout.

The link generation system 300 transmits additional data in the link results 220 along with the application access mechanisms 202a. For example, the link generation system 300 may transmit data (e.g., link data 262, such as text and/or images), which may be used by the user device 200 to generate state links 260. A state link 260 may include text and/or images that the user 10 may select (e.g., touch) via a user interface 240 displayed on a screen 201 (e.g., a display or touch screen) of the user device 200. Each state link 260 may be associated with an application access mechanism 202a such that when the user 10 selects a state link 260, the user device 200 launches the native application 204a referenced in the application access mechanism 202a and performs the one or more operations indicated in the application access mechanism 202a. The text and/or images of a state link 260 displayed to the user 10 may indicate the action that will be performed in response to selection of the state link 260. For example, if the link 260 is to a song in a music playing application, the text and/or images may identify the music application that will be launched by the user device 200 and the song that will be played by the music playing application when the user 10 selects the state link 260.

The user 10 may select a state link 260 or link 250 (hereafter link 250, 260) that causes the user device 200 to launch the native application 204a identified by the link 250, 260 and perform one or more operations according to the application access mechanism 202a associated with the link 250, 260. Put another way, when the user 10 selects a link 250, 260 the user device 200 launches a native application 204a and sets the native application 204a into a state defined by the application access mechanism 202a associated with the link. In general, a state of a native application 204a may refer to the operations and/or the resulting outcome of the native application 204a in response to selection of a link 250, 260. A state of a native application 204a may also be referred to herein as an “application state.”

A web access mechanism 202b may include a resource identifier that includes a reference to a web resource (e.g., a page of a web application/website). For example, a web access mechanism 202b may include a uniform resource locator (URL) (i.e., a web address) used with hypertext transfer protocol (HTTP). If a user 10 selects a link 250, 260 including a web access mechanism 202b, the user device 200 may launch the web browser application 204b and retrieve the web resource indicated in the resource identifier. Put another way, if a user 10 selects a link 250, 260 including a web access mechanism 202b, the user device 200 may launch a corresponding web-browser application 204b and access a state (e.g., a page) of a web application/website. In some examples, web access mechanisms 202b include URLs for mobile-optimized sites and/or full sites.

The web access mechanism 202b included in an entity record 340 and/or application state record 360 may be used by a web browser to access a web resource that includes similar information and/or performs similar functions as would be performed by a native application 204a that receives an application access mechanism 202a of the entity record 340 and/or application state record 360. For example, the web access mechanism 202b of an entity record 340 and/or application state record 360 may direct the web-browser application 204b of the user device 200 to a web version of the native application 204a referenced in the application access mechanisms 202a of the entity record 340 and/or application state record 360. Moreover, if the application access mechanisms 202 included in an entity record 340 and/or application state record 360 for a specific Mexican restaurant cause each application edition to retrieve information for the specific Mexican restaurant, the web access mechanism 202b may direct the web-browser application 204b of the user device 200 to a web page entry for the specific Mexican restaurant.

An application download mechanism 202c may indicate a location (e.g., a digital distribution platform 130b) where a native application 204a can be downloaded in the scenario where the native application 204a is not installed on the user device 200. If a user 10 selects a link 250, 260 including an application download mechanism 202a, the user device 200 may access a digital distribution platform from which the referenced native application 204a may be downloaded. The user device 200 may access a digital distribution platform 130b using at least one of the web-browser application 204b and one of the native applications 204a.

An application access mechanism 202a included in an entity record 340 and/or application state record 360 may be an application resource identifier or a string that includes a reference to a native application 204a and/or indicates one or more operations for execution by the native application 204a on the user device 200. An application resource identifier may be a string having an application specific scheme in some examples. For example, the application resource identifier may include a reference to a native application 204a, a domain name, and a path to be used by the native application 204a to retrieve and display information to the user 10. In some examples, an application resource identifier is an application specific resource identifier that is defined by the developer of the application 204. In this example, the link generation application 216 receives the application resource identifier and the operating system 228 may send the application resource identifier to the native application 204a referenced in the application resource identifier. The native application 204a referenced in the application resource identifier launches and is set into the state specified by the application resource identifier.

A single native application 204a may provide a variety of different actions. For example, a restaurant reservation application can access reviews for a variety of different restaurants and set up reservations at a variety of different restaurants. Similarly, a travel application can book hotels, book flights, and provide reviews for different travel destinations. The different actions associated with a single native application 204a may be accessed using a plurality of different application access mechanisms 202. For example, with respect to the restaurant reservation application, the application data store 350 may include application state records 360 having different application access mechanisms 202 for booking hotels, booking flights, and accessing reviews for different travel destinations.

Referring to FIGS. 3A-4C, the link generation module 310 may include data in the link results 220 instructing the client link module 217 where (e.g., a location within a currently displayed application state 252) to display one or more state links 260. For example, as depicted by FIG. 3A, the link generation module 310 (e.g., via the link results 220) may instruct the client link module 217 to place the state links 260 at the bottom of the currently displayed application state 252. In other implementations, the link generation module 310 may instruct the client link module 217 to place the state links 260 on the sides, top, and/or other location of a currently displayed application state 252. In some implementations, such as when the client link module 217 is executed by a launcher or operating system 228, the link results 220 may indicate that state links 260 should be placed adjacent to an application state instead of within an application state (see, e.g., FIGS. 4A-4C).

The client link module 217 may transmit a link request 210 in response to a native application entering the current displayed application state 252 (e.g., in response to an automatic event). The client link module 217 may then render one or more state links 260 upon receipt of the link data 262 from the link generation system 300. Although the client link module 217 may transmit a link request 210 in response to the opening of the current displayed application state 252, in other implementations, the client link module 217 may transmit the link request 210 in response to other events (e.g., a manual event). In one example, the current displayed application state 252 may include a user interface element (e.g., a button) with which the user 10 may interact in order to transmit the link request 210. For example, the button (not shown) may include the text “request additional actions.” In additional examples, an event may include a user scrolling down the screen. For example, the client link module 217 may transmit the link request 210 upon detecting that the user 10 has scrolled down the screen past a specific point or to the end of the page.

As shown in FIGS. 3A and 3C, the current application state 252 is a state of a travel application, TRIPADVISOR® (developed by TripAdvisor, Inc.) displaying a hotel name and a price estimate. In addition, the current application state 252 includes a user-selectable link 250 that indicates the action “show prices,” which, upon selection by a user, may cause the user device 200 to provide a detailed listing of prices for available rooms. The client link module 217 additionally displays two state links 260a, 260b (“call taxi” 260a and “make reservation” 260b) that provide different actions than the action provided by the current application 252 (e.g., “show prices”). The state links 260a, 260b are shown as buttons at the bottom of the GUI 240. The state links 260 may be displayed in other areas of the GUI 240, such as the top or sides.

In another example, and as shown in FIGS. 3B and 3D, the current application state 252 shows a state of a business review application, YELP® (developed by Yelp, Inc.), that provides several actions accessible upon selection of a link 250, such as a “get directions” link 250a, a “call location” link 250b, and an “explore the menu” 250c link. In this example, the client link module 217 receives link results 220 that may be used to generate state links 260 to application states with different actions than the actions provided by the current application state 252. For example, the state links 260 may provide the actions “order food” (e.g., via the state link 260c) and “find coupons” (e.g., via the state link 260d). Furthermore, in these example, both of the state links 260 in FIGS. 3B and 3D include text indicating that they are advertised state links 260. As such, in this example, the link generation system 300 provides the user access to useful application states in addition to taking advantage of an advertising opportunity. Accordingly, FIGS. 3B and 3D provide an example of a scenario where the link generation system 300 may generate revenue using the advertising system 400.

The client link module 217 may be included on a user device 200 separately from a native application 204 (e.g., not part of a native application 204). In one example, the client link module 217 may be implemented by the operating system executing a launcher. In another example, as illustrated in FIG. 4A, the client link module 217 may be implemented by a third party application executing a launcher. In each example, the client link module 217 executes separately from the native applications 204 being enhanced with state links 260. More specifically, client link module 217 may run as a background process that may detect a current application state 252 and may also detect when an automatic or manual event occurs. For example, the client link module 217 may transmit link requests 210 upon detecting an automatic event, such as a user 10 entering a current displayed application state 252. In some examples, the client link module 217 may transmit link requests 210 upon detection of a manual event occurring within a current application state 252, such as a user 10 selecting a rendered UI element (e.g., swiping the launcher UI element). The client link module 217 (e.g., via a launcher) may render the state links 260 outside of the current application in a dedicated location 263 (e.g., in an overlay component of the GUI 240).

Referring to FIG. 4A, the current displayed application state 252 shows a state of the TRIPADVISOR® application (developed by TripAdvisor, Inc.) displaying a hotel name and a price per night. In addition, the current application state 252 displays a link 250 that, upon user selection, may perform the action “show prices” (e.g., cause the user device to provide a detailed listing of prices for available rooms). The client link module 217 additionally displays two state links 260a, 260b, each performing a different action than the action of the current application state 252 (e.g., “call taxi” and “make reservation”) in a dedicated location 263. The state links 260a, 260b are displayed (e.g., overlaid over the GUI of the current application state 252) as buttons in the dedicated location 263. The dedicated location 263 may be displayed in other areas of the GUI 240, such as the top or side of the GUI 240.

Referring to FIGS. 4B and 4C, the current application state 252 shows a state of the YELP® application (developed by Yelp, Inc.) that provides the actions “get directions,” “call,” and “explore the menu” (e.g., via the links 250a, 250b, 250c respectively). In this example, client module 217 executes separately from the current application 252 and receives link results 220 including link data 262 used to provide state links 260 that perform different actions than the current application state 252. Specifically, the state links 260c, 260d may cause the user device 200 to perform the actions “order food” and “find coupons,” which may enhance the user's experience. FIGS. 4B and 4C illustrate a manual event where a user 10 interacts with a launcher overlay. More specifically, the user 10 expands a location button 265 to display a list 261 of state links 260. The user 10 may either swipe the location button 265 upwards in order to view the state links 260 or press the location button 265. To minimize the list 261, the user 10 may swipe the location button towards the bottom of the display screen 201 or press the location button 265 when in the expanded form.

Referring back to FIG. 1B, the data sources 130 may be sources of data that the link generation system 300 may use to generate and update the entity data store 330 and/or the application state data store 350. The data retrieved from the data sources 130 can include any type of data related to application actions and/or application states. Data retrieved from the data sources 130 may be used to create and/or update one or more databases, indices, tables (e.g., an access table), files, or other data structures included in the entity data store 330 and/or application state data store 350. For example, application state records 360 and entity records 340 may be created and updated based on data retrieved from the data sources 130. In some examples, some data included in a data source 130 may be manually generated by a human operator. Data included in the application state records 360 and entity records 340 may be updated over time so that the link generation system 300 provides up-to-date results.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 204a to user devices 200. Example digital distribution platforms 130b may include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include web logs 130c (i.e., blogs), application review websites 130d, or other websites including data related to applications. Additionally, the data sources 130 may include social networking sites 130e, such as “FACEBOOK®” by Facebook, Inc. (e.g., Facebook posts) and “TWITTER®” by Twitter Inc. (e.g., text from tweets). Data sources 130 may also include online databases 130f that include, but are not limited to, data related to movies, television programs, music, and restaurants. Data sources 130 may also include additional types of data sources in addition to the data sources described above. Different data sources 130 may have their own content and update rate.

Referring to FIGS. 5A and 5B, the entity data store 330 includes a plurality of different entity records 340. Each entity record 340 may include data related to an entity. The entity can be a person, place, or thing (e.g., restaurants, bars, gas stations, supermarkets, celebrities, products, movie theaters, doctor offices, parks, and libraries, etc.). An entity record 340 may include an entity identifier or name (ID) 342, entity location data 346 (e.g., geolocation data), an entity category 348 (and optionally one or more sub-categories 348a-348n), entity information 344, and associated entity actions 349.

The entity ID 342 may be used to identify the entity record 340 among the other entity records 340 included in the entity data store 330. The entity ID 342 may be a string of alphabetic, numeric, and/or symbolic characters (e.g., punctuation marks) that uniquely identifies the associated entity record 340. In some examples, the entity ID 342 describes the entity in human readable form. For example, the entity ID 342 may include the name of the entity. In some examples, the entity ID 342 includes a string in the format of a uniform resource locator (URL).

In a more specific example, if the entity record 340 describes a restaurant named Qdoba® (QDOBA is a registered trademark of the Qdoba Restaurant Corporation), the entity ID 342 for the entity record 340 can be “Qdoba.” In an example where the entity ID 342 includes a string in human readable form and/or a URL, the entity ID 342 may include the following string “Qdoba, 42967 Woodward Avenue, Bloomfield Township, Mich. 48304” to uniquely identify the entity record 340. Other unique identifiers are possible as well, such as unique identifiers based on a store number.

The entity information 344 may include any information about the entity, such as text (e.g., description, reviews) and numbers (e.g., number of reviews). This information may even be redundant to other information contained in the entity record 340. The entity information 344 may include a variety of different types of data, such as structured, semi-structured, and/or unstructured data. Moreover, the entity information 344 may be automatically and/or manually generated based on documents retrieved from the data sources 130.

The entity location data 346 may include data that describes a location of the entity. This data may include a geolocation (e.g., latitude and longitude coordinates), a street address, or any information that can be used to identify the location of the entity within a geographical area. In some implementations, the entity location data 346 may define a geo-location associated with the application state record 360.

The entity category 348 provides a classification of the entity. The entity category 348 can have one or more sub-categories to further classify the entity. For example, the entity record 340 could have an entity category 348 of “restaurant” and a sub-category 348a indicating a type of cuisine, such as “French cuisine” or “contemporary.” Any number of sub-categories 348a-348n may be assigned to classify the entity for use during a search.

The associated entity action(s) 349 provide one or more access mechanism 202 associated with the entity ID 342. Each access mechanism 202 of the associated entity action 349 corresponds to an action associated with a different application. For example, with respect to FIG. 5B, the associated entity actions(s) 349 of an entity record for the entity “Qdoba” may include an access mechanism 202 for the reservation application OPENTABLE® (developed by OpenTable, Inc.) and indicate an action corresponding to the access mechanism, such as “Order Online.” Another associated entity action 349 for the entity “Qdoba” may correspond to the business review application YELP® (developed by Yelp, Inc.) and be associated with the action “Provide Reviews.” Other examples are possible as well. In this way, an entity record 340 includes multiple actions associated with the entity (“Qdoba”) and each action can be associated with an access mechanism.

Referring to FIGS. 5C and 5D, the application data store 350 includes a plurality of different application state records 360. Each application state record 360 may include data related to a state of an application (e.g., an application state associated with one or more actions). An application state record 360 may include an application state identifier (ID) 362, location data 364, one or more access mechanisms 202, 202a, 202b, 202c used to access the application state, associated state actions(s) 349, associated entity IDs 368, and an application ID 369 identifying the application 204 to which the application record 360 corresponds. The link generation system 300 (via modules not shown) may populate the application state records 360 with data acquired from the data sources 130.

The application state ID 362 may be used to identify the application state record 360 among the other application state records 360 included in the application data store 350. The application state ID 362 may be a string of alphabetic, numeric, and/or symbolic characters (e.g., punctuation marks) that uniquely identifies the associated application state record 360. In some examples, the application state ID 362 describes an application state and/or action in human readable form. For example, the application state ID 362 may include the name of the application referenced in the access mechanism(s) 202. In a specific example, an application state ID 362 for an internet music player application may include the name of the internet music player application along with the song name that will be played when the internet music player application is set into the state defined by the access mechanism included in the application state record 360. Additionally or alternatively, the application state ID 362 may be a human readable string that describes an action performed according to the access mechanism(s) 202 and/or an application state accessed using the access mechanism(s). In some examples, the application state ID 362 includes a string in the format of a uniform resource locator (URL) of a web access mechanism 202b for the application state record 360, which may uniquely identify the application state record 360.

FIG. 5D illustrates an example application state record 360 associated with an application state of the YELP® application. Specifically, the application state is associated with the restaurant named “The French Laundry.” The application state record 360 includes an application state ID 362 that may include the name “Yelp.” For example, the application state ID 362 for an application state record 360 that describes the restaurant named “The French Laundry” may be “Yelp—The French Laundry.” In an example where the application state ID 362 includes a string in the format of a URL, the application state ID 362 may include the following string “http://www.yelp.com/biz/the-french-laundry-yountville-2?ob=1” to uniquely identify the application state record 360. In additional examples, the application state ID 362 may include a URL using a namespace other than “http://,” such as “func://.” For example, the application state ID 362 may include the following string “func://www.yelp.com/biz/the-french-laundry-yountville-2?ob=1.”

The associated state action(s) field 366 identifies an action for each one of the access mechanism(s) of the application state record 360. For example, if the application state record 360 is for an application that provides restaurant reviews, then the associated state action 366 may be “Review Business.” As another example, if the application state record 360 is for an application that provides directions to a location, then the associated state action 366 may be “Navigate To.” For example, the associated state actions(s) 366 of FIG. 5D for the application state record 360 of the YELP® application may be ‘make reservations,’ find taxi,' and ‘navigate to.’

The associated entity name or identifier (ID) 368 identifies an entity associated with the application state. For example, if the application state record 360 is for an application that provides restaurant reviews, then the associated entity ID 368 may include a name of a restaurant. As another example, if the application state record 360 is for an application that provides directions to a location, then the entity indicated by the associated entity ID 368 may be a location to which the application can navigate. As an example, an associated entity ID for the application state record 360 illustrated in FIG. 5D may be “The French Laundry,” which is the name of a restaurant (i.e., an entity). In some examples, the application state record 360 includes an application identifier (ID) 369 identifying an application associated with the application state record.

In some implementations, an application state record 360 includes multiple different application access mechanisms 202a. Different application access mechanisms 202 may be associated with different editions of a native application 204a. A native application edition (hereinafter “application edition”) refers to a particular implementation or variation of a native application 204a. For example, an application edition may refer to a version of a native application 204a, such as a version 1.0 of a native application 204a or a version 2.0 of a native application 204a. In another example, an application edition may refer to an implementation of a native application 204a for a specific platform, such as a specific operating system 228. The application access mechanisms 202 may include edition information that indicates the application edition with which the application access mechanism 202 is compatible. For example, the edition information may indicate the operating system with which the application access mechanism 202 is compatible.

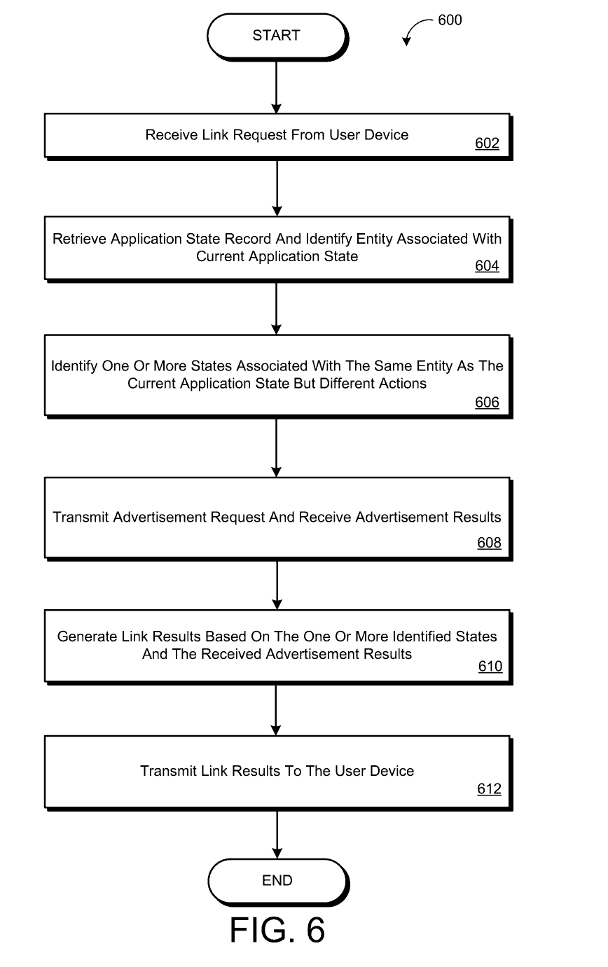

FIG. 6 provides an example arrangement of operations for a method 600 of identifying one or more state links 260 using the link generation system 300 of FIG. 2. At block 602, the link generation module 310 receives a link request 210 from a user device 200. The link request 210 includes current application state data 212 corresponding to a currently accessed application state 252. At block 604, the link generation module 310 retrieves an application state record 360 based on the current application state data 212 and identifies an entity associated with the currently accessed application state 252.

At block 606, the link generation module 310 may retrieve an entity record 340 associated with the identified entity. The link generation module 310 may utilize the entity record 340 (e.g., associated entity actions 349) to identify application states with the same entity but different actions than the application state indicated in the link request 210. The link generation module 310 may additionally or alternatively access the application state data store 350 based on the information in the link request 210 and/or entity record 340 to retrieve application state records 360 of application states associated with the same entity but different actions than those indicated in the link request 210.

At block 608, the link generation module 310 transmits an advertisement request 412 based on the currently displayed application state 252 to the advertisement system 400. The link generation module 310 includes the identified entity and one or more actions of the currently accessed application state 252 in the advertisement request 412. The link generation module 310 may additionally include data related to the identified application states or an advertisement request number (e.g., a specific quantity of requested advertised state links 260) in the advertisement request 412. The link generation module 310 receives advertisement results 422 from the advertisement system 400 in response to the advertisement request 412.

At block 610, the link generation module 310 generates link results 220 based on the one or more identified states and the received advertisement results 422. The link generation module 310 may include access mechanisms 202 corresponding to the identified states and received advertisement results 422 in the link results 220. The link generation module 310 may also include additional data in the link results 220, such as link data 262. The link generation module 310 may select one or more of the application states (e.g., access mechanisms 202) indicated by the retrieved records or advertisement results 422 to be used to generate the link results 220. For example, the link generation module 310 may filter application states based on an advertisement opportunity. In this way, the link generation module 310 may include advertised state links 260 over non-advertised state links 260 in the link results 220. At block 612, the link generation module 310 transmits the link results 220 to the client link module 217, where a user device 200 may display the received link results 220 as advertised and/or non-advertised user-selectable state links 260.

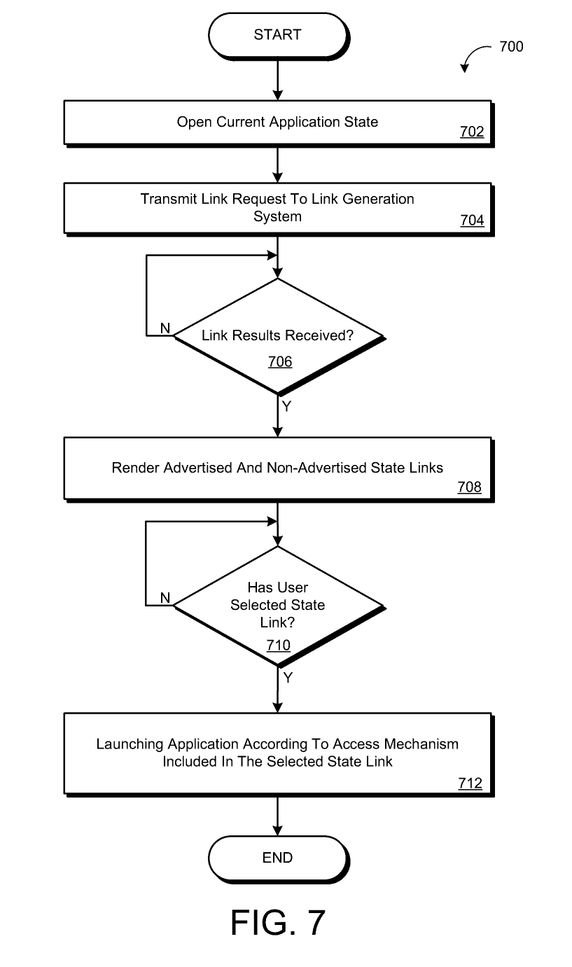

FIG. 7 illustrates an example method 700 for transmitting a link request 210 to a link generation system 300 and displaying user-selectable state links 260. At block 702, the user device 200 opens a current application state 252. At block 704, the user device 200 transmits a link request 210 to a link generation system 300. At block 706, the user device 200 determines (e.g., via the client link module 217) whether it has received link results 220 from the link generation module 310. When the user device 200 determines that it has received the link results 220, the method proceeds to block 708. At block 708, the user device 200 (e.g., via the client link module 217) renders and displays the received link results 220 as state links 260. The state links 260 may include advertised state links 260 and non-advertised state links 260. At decision block 710, the user device 200 determines when the user 10 selects a state link 260. At block 712, once the user 10 selects a state link 260, the user device 200 launches an application according to an access mechanism 202 associated with the selected state link 260.

FIG. 9A illustrates a method 900 for generating advertisement records 430. At block 902, the advertisement record generation module 450 generates a GUI for a campaign manager and transmits the GUI to an advertiser device 50 in a manner that allows the advertiser to input data values for the parameters of an advertisement record 430. For example, as depicted by FIG. 1C, a campaign manager GUI may provide input fields for data values that correspond to data that may be used to populate an advertisement record 430. At block 904, the advertisement record generation module 450 receives the data values input by an advertiser (e.g., via an advertiser device 40) for an advertisement record 430. At block 906, the advertisement record generation module 450 generates an advertisement record 430 based on the received data. At block 908, the advertisement record generation module 450 stores the generated advertisement record 430 in the advertisement data store 420.

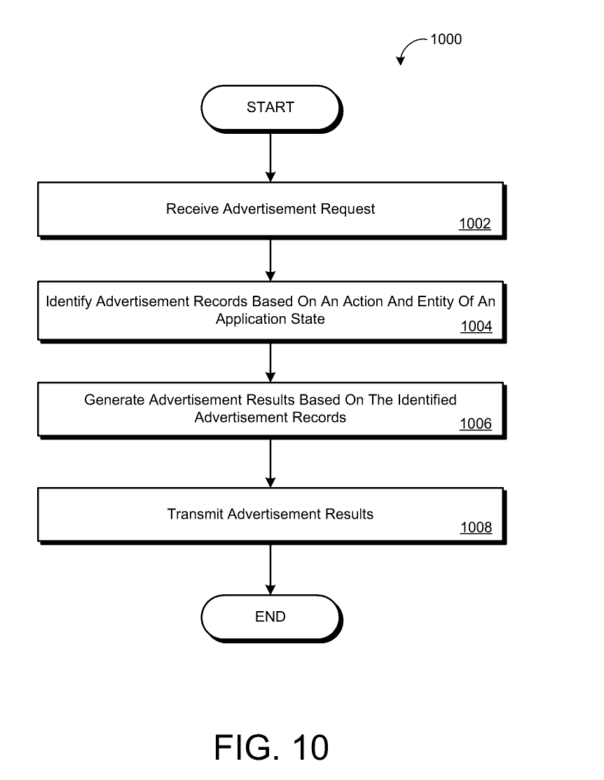

FIG. 10 illustrates a method 1000 for generating advertisement results 422 based on an advertisement request 412 including an action and entity of an application state (e.g., a currently accessed application state 252). At block 1002, the advertisement module 410 receives an advertisement request 412 (e.g., from the link generation module 310). At block 1004, the advertisement module 410 identifies potential advertisements (e.g., advertisement records 430) based on the action and entity of the application state. At block 1006, the advertisement module 410 generates advertisement results 422 based on one or more of the identified advertisement records 430. At block 1008, the advertisement module 410 transmits advertisement results 422 (e.g., to the link generation module 310). The link generation module 310 may utilize the advertisement results 422 to configure link results 220 for render and display within or alongside an application state.

Though the link results 220 are described above as being generated based on application state records 360 retrieved from the application state data store 350, the application state records 360 may be dynamically generated. In these examples, the link generation module 310 may utilize an action ontology stored in the application state data store 350 to determine actions related to an application state without accessing the application state data store 350. In some implementations, instead of being stored in the application state data store 350, the action ontology may be hardcoded or preprogrammed into the link generation system 300.

In implementations using dynamically generated application state records 360, the link generation module 310 may utilize the action ontology to generate application state records 360 associated with the same entity as the entity of the link request, but that perform different actions than the action of the link request. The link generation module 310 may select actions from the ontology and utilize information provided by the data sources 130 corresponding to the selected actions to generate dynamic application state records 360. In this way, the link generation module 310 may provide link results 220 without the use of application state records 360 stored in a data store.

Modules and data stores included in the systems 300, 400 represent features that may be included in the systems 300, 400 of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

In some implementations, the systems 300, 400 may be systems of one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems 300, 400 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems 300, 400 may be configured to communicate with the network 120. The one or more computing devices of the systems 300, 400 may also be configured to communicate with one another (e.g., via a computer network). In some examples, the one or more computing devices of the systems 300, 400 may include one or more server computing devices configured to communicate with user devices, gather data from data sources 130, index data, store the data, and store other documents. The one or more computing devices may reside within a single machine at a single geographic location in some examples. In other examples, the one or more computing devices may reside within multiple machines at a single geographic location. In still other examples, the one or more computing devices of the systems 300, 400 may be distributed across a number of geographic locations.

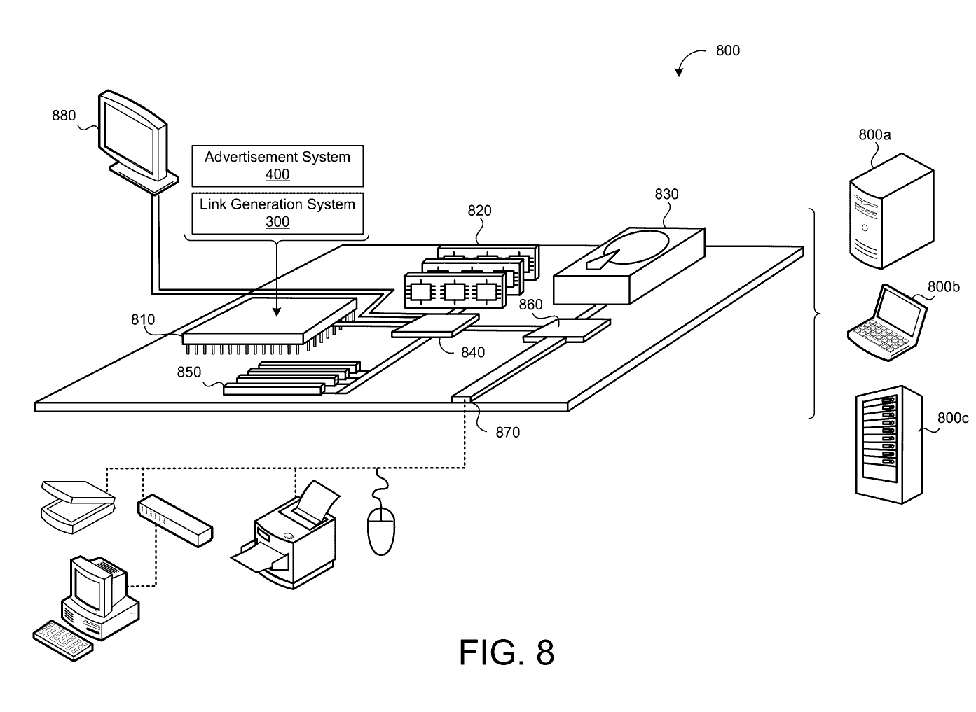

FIG. 8 is a schematic view of an example computing device 800 that may be used to implement the systems and methods described in this document. The computing device 800 is intended to represent various forms of digital computers, such as laptops, desktops, workstations, smartphones, servers, blade servers, mainframes, and other types of computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to low speed bus 870 and storage device 830. Each of the components 810, 820, 830, 840, 850, and 860, are interconnected using various busses, and may be mounted on a common motherboard or in other manners. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium. For example, the memory may include volatile/nonvolatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM), programmable read-only memory (PROM), erasable programmable read-only memory (EPROM), and electronically erasable programmable read-only memory (EEPROM) (e.g., typically used for firmware, such as boot programs). Examples of volatile memory include, but are not limited to, random access memory (RAM), dynamic random access memory (DRAM), and static random access memory (SRAM).

The storage device 830 is capable of providing mass storage for the computing device 800. In some implementations, the storage device 830 is a computer-readable medium. In various different implementations, the storage device 830 may be a floppy disk device, a hard disk device, an optical disk device, a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and low-speed expansion port 870. The low-speed expansion port 870, which may include various communication ports (e.g., USB, Bluetooth, Ethernet, wireless Ethernet), may be coupled to one or more input/output devices, such as a keyboard, a pointing device, a scanner, or a networking device, such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although operations may be depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at an advertisement system including one or more processing units, advertisement data from a plurality of advertiser devices;
generating, by the advertisement system, a plurality of advertisement records in an advertisement data store based on the advertisement data received from the plurality of advertiser devices, wherein each of the advertisement records includes:
an entity name associated with an advertisement;
an action associated with the advertisement; and
a bid price indicating an amount of money associated with the advertisement;
receiving, by the advertisement system, an advertisement request from a link generation system, the advertisement request including an entity name and an action associated with a currently accessed application state on a user device;
selecting, by the advertisement system, an advertisement record having the entity name indicated in the advertisement request and having a different action than the action indicated in the advertisement request;
generating, by the advertisement system, an advertisement result based on the selected advertisement record, wherein the advertisement result is configured to be displayed with the currently accessed application state on the user device; and
transmitting, by the advertisement system, the advertisement result to the link generation system.

2. The method of claim 1, further comprising:
receiving, at the link generation system, a link request from the user device, wherein the link request includes data indicating the currently accessed application state;
generating, by the link generation system, the advertisement request based on the link request;
transmitting, by the link generation system, the advertisement request to the advertisement system;
receiving, by the link generation system, the advertisement result from the advertisement system;
generating, by the link generation system, an advertised link to an application state based on the advertisement result and the link request; and
transmitting, by the link generation system, the advertised link to the user device.

3. The method of claim 2, wherein each advertisement record further comprises advertisement content associated with an application state, and wherein the method further comprises including, by the advertisement system, advertisement content in the advertisement result for display on the user device in the advertised link.

4. The method of claim 2, wherein the link request includes an action and an entity associated with the currently accessed application state.

5. The method of claim 2, wherein the link request includes an access mechanism configured to launch the currently accessed application state.

6. The method of claim 2, wherein each advertisement record includes a reference to an application state, and wherein the advertisement request includes data indicating one or more links to one or more application states, the method further comprising:
selecting, by the advertisement system, one or more of the indicated links that are associated with an application state referenced by an advertisement record; and
generating, by the advertisement system, advertisement results based on the selected links.

7. The method of claim 2, further comprising:
selecting, by the advertisement system, one or more additional advertisement records having the entity name indicated in the advertisement request and having a different action than the action indicated in the advertisement request;
generating, by the advertisement system, one or more additional advertisement results based on the additional advertisement records, wherein the additional advertisement results are configured to be displayed with the currently accessed application state on the user device; and
transmitting, by the advertisement system, the additional advertisement results to the link generation system.

8. The method of claim 7, wherein the link generation system transmits one or more advertised links and one or more non-advertised links to application states to the user device.

9. The method of claim 7, wherein the advertisement request includes an advertisement request number indicating a number of advertisement results being requested by the link generation system, the method further comprising generating, by the advertisement system, the number of advertisement results indicated by the advertisement request number.

10. The method of claim 1, further comprising:
generating, by the advertisement system, graphical user interfaces for the plurality of advertiser devices, wherein the graphical user interfaces are configured to receive the advertisement data from an advertiser; and
generating, by the advertisement system, the plurality of advertisement records in the advertisement data store based on the advertisement data received via the graphical user interfaces.

11. The method of claim 1, wherein the entity name of each advertisement record is associated with an application state, wherein the action of each advertisement record is associated with the application state, and wherein the bid price of each advertisement record is associated with the application state.

12. The method of claim 1, wherein each advertisement record further comprises advertisement targeting parameters that specify conditions for generating the advertisement, and wherein the method further comprises selecting the advertisement record when contents of the advertisement request satisfy the advertisement targeting parameters.

13. The method of claim 1, wherein the bid price indicates at least one of i) an amount of money to be paid by an advertiser in exchange for display of the advertisement result and ii) an amount of money to be paid by an advertiser in exchange for user selection of a user-selectable link associated with the advertisement result.

14. A system comprising:
a data store comprising one or more storage devices; and
an advertisement system including one or more computing devices, wherein the advertisement system is configured to:
receive advertisement data from a plurality of advertiser devices;
generate a plurality of advertisement records in the data store based on the advertisement data received from the plurality of advertiser devices, wherein each of the advertisement records includes:
an entity name associated with an advertisement;
an action associated with the advertisement; and
a bid price indicating an amount of money associated with the advertisement;
receive an advertisement request from a link generation system, the advertisement request including an entity name and an action associated with a currently accessed application state on a user device;
select an advertisement record having the entity name indicated in the advertisement request and having a different action than the action indicated in the advertisement request;
generate an advertisement result based on the selected advertisement record, wherein the advertisement result is configured to be displayed with the currently accessed application state on the user device; and
transmit the advertisement result to the link generation system.

15. The system of claim 14, further comprising a link generation system including one or more computing devices, wherein the link generation system is configured to:
receive a link request from the user device, wherein the link request includes data indicating the currently accessed application state;
generate the advertisement request based on the link request;
transmit the advertisement request to the advertisement system;
receive the advertisement result from the advertisement system;
generate an advertised link to an application state based on the advertisement result and the link request; and
transmit the advertised link to the user device.

16. The system of claim 15, wherein each advertisement record further comprises advertisement content associated with an application state, and wherein the advertisement system includes advertisement content in the advertisement result for display on the user device in the advertised link.

17. The system of claim 15, wherein the link request includes an action and an entity associated with the currently accessed application state.

18. The system of claim 15, wherein the link request includes an access mechanism configured to launch the currently accessed application state.

19. The system of claim 15, wherein each advertisement record includes a reference to an application state, and wherein the advertisement request includes data indicating one or more links to one or more application states, and wherein the advertisement system is further configured to:
select one or more of the indicated links that are associated with an application state referenced by an advertisement record; and
generate advertisement results based on the selected links.

20. The system of claim 15, wherein the advertisement system is further configured to:
select one or more additional advertisement records having the entity name indicated in the advertisement request and having a different action than the action indicated in the advertisement request;
generate one or more additional advertisement results based on the additional advertisement records, wherein the additional advertisement results are configured to be displayed with the currently accessed application state on the user device; and
transmit the additional advertisement results to the link generation system.

21. The system of claim 20, wherein the link generation system transmits one or more advertised links and one or more non-advertised links to application states to the user device.

22. The system of claim 20, wherein the advertisement request includes an advertisement request number indicating a number of advertisement results being requested by the link generation system, and wherein the advertisement system is further configured to generate the number of advertisement results indicated by the advertisement request number.

23. The system of claim 14, wherein the advertisement system is further configured to:
generate graphical user interfaces for the plurality of advertiser devices, wherein the graphical user interfaces are configured to receive the advertisement data from an advertiser; and
generate the plurality of advertisement records in the advertisement data store based on the advertisement data received via the graphical user interfaces.

24. The system of claim 14, wherein the entity name of each advertisement record is associated with an application state, wherein the action of each advertisement record is associated with the application state, and wherein the bid price of each advertisement record is associated with the application state.

25. The system of claim 14, wherein each advertisement record further comprises advertisement targeting parameters that specify conditions for generating the advertisement, and wherein the advertisement system is further configured to select the advertisement record when contents of the advertisement request satisfy the advertisement targeting parameters.

26. The system of claim 14, wherein the bid price indicates at least one of i) an amount of money to be paid by an advertiser in exchange for display of the advertisement result and ii) an amount of money to be paid by an advertiser in exchange for user selection of a user-selectable link associated with the advertisement result.
